(19) United States
(12) Patent Application Publication
(10) Pub. No.: US 2026/0312090 A1
(43) Pub. Date: Oct. 8, 2026

(54) ELECTRO-SYNTHETIC OR ELECTRO-ENERGY CELL, SYSTEM, AND METHOD OF OPERATION

(71) Applicant: Hysata Pty Ltd, Port Kembla, New South Wales (AU)

(72) Inventors: Chong-Yong LEE, Wollongong, New South Wales (AU); Gerhard Frederick SWIEGERS, North Wollongong, New South Wales (AU); Adam WARBURTON, Figtree, New South Wales (AU); George TSEKOURAS, Corrimal, New South Wales (AU)

(21) Appl. No.: 19/485,043

(22) PCT Filed: May 17, 2024
(86) PCT No.: PCT/AU2024/050499

§ 371 Date: Nov. 17, 2025

(30) Foreign Application Priority Data
May 18, 2023 (AU) 2023901537

(51) Int. Cl. H01M 8/04186; C25B 13/02; C25B 13/08; C25B 15/08; H01M 8/0239

(52) U.S. Cl. CPC H01M 8/04186; C25B 13/02; C25B 13/08; C25B 15/08; H01M 8/0239

(57) ABSTRACT

Electro-synthetic or electro-energy cells and systems that display low impedances despite employing poorly conductive liquid electrolytes, and methods of operation of such cells and systems. In one example there is provided an electro-synthetic or electro-energy cell, including a first electrode, a second electrode and a liquid flow channel positioned between the first electrode and the second electrode. The liquid flow channel supplies a liquid electrolyte and the liquid flow channel is narrow. A porous spacer, which can be a porous capillary spacer, may be positioned in the liquid flow channel. In another example there is provided a method of operation of the cell including filling the flow channel with a highly conductive liquid electrolyte and applying a potential difference between the first electrode and the second electrode. During operation of the cell the poorly conductive liquid electrolyte flows through the flow channel.

### TECHNICAL FIELD

The invention broadly relates to electro-synthetic or electro-energy cells, their supporting systems, and their methods of operation. Example embodiments relate to electro-synthetic or electro-energy cells and systems that display low impedances despite employing poorly conductive liquid electrolytes, and methods of operation of such cells and systems. Such poorly conductive liquid electrolytes may reduce corrosion rates, leading to amplified durability, performance, and/or other improvements.

### BACKGROUND

An electro-energy cell is an industrial electrochemical cell that can generate substantial quantities of electrical power over sustained periods of time, for use outside of the cell. Electro-energy cells are distinguished from other galvanic cells in that they require a constant external supply of reactants. The products of the electrochemical reaction must also be constantly removed from such cells. Unlike a battery, an electro-energy cell does not store chemical or electrical energy within the electro-energy cell.

Examples of electro-energy cells include but are not limited to Polymer Electrolyte Membrane (PEM) hydrogen-oxygen fuel cells, hydrogen-oxygen alkaline fuel cells, ammonia fuel cells, and the like.

An electro-synthetic cell is, similarly, an industrial electrochemical cell that can manufacture substantial quantities of one or more chemical materials over sustained periods of time, for use outside of the cell. The chemical materials may be in the form of a gas, liquid, or solid. Like an electro-energy cell, an electro-synthetic cell also requires a constant supply of reactants and a constant removal of products. Electro-synthetic cells may generally further require a constant input of electrical energy.

Examples of electro-synthetic cells include but are not limited to electrochemical cells for manufacturing hydrogen (‘water electrolyzers’), chlorine (‘chlor-alkali’ cells), hydrogen peroxide, formic acid, ammonia, and a host of other industrial products.

Because large quantities of electrical energy may be required to operate electro-synthetic or electro-energy cells, a key challenge in their development is to make them as energy efficient as possible during operation. This may be achieved, in part, by minimizing their electrical impedance. Impedance is the opposition that a cell presents to an electrical current. It may be represented in terms of the area specific resistance (ASR) of the cell, which is typically expressed in units of: Ω cm². The ASR provides a measure of the electrical resistance of the liquid electrolyte between the electrodes, to the electrical current. A low ASR correlates with a low electrical resistance, which correlates, in turn, with a high conductivity between the electrodes. A high conductivity between the electrodes may generally be due to a large excess of ions between the electrodes, which typically strongly promotes high catalytic activity by the electro-catalysts employed on the cathode and anode electrodes.

One well-known method of minimizing impedance is to employ a cell architecture in which the anode and cathode electrodes of the cell are placed facing each other, as close as possible to each other, without touching (which would create a short circuit). The gap between the two electrodes should then, ideally, also be occupied by an electrolyte that has the highest possible conductivity and that includes high concentrations of ions/molecules that are exchanged by the electrodes during the electrochemical reaction, thereby promoting high catalytic activity by the electro-catalysts employed on the cathode and anode electrodes. In general, liquid electrolytes have, as a class, the highest conductivities of any electrolyte. An inter-electrode membrane/ionomer/diaphragm (also called a ‘separator’ or a ‘spacer’) is usually placed between the electrodes to prevent the electrodes from touching and to maintain the reactants consumed by and/or the products generated by each electrode, separate from each other.

Another feature of industrial electro-synthetic or electro-energy cells is that the liquid electrolyte used in them may be highly corrosive. For example, most present-day commercial alkaline electrolyzers employ 27-32 wt % KOH as an aqueous, liquid electrolyte because it: (1) is highly conductive, and (2) strongly promotes high catalytic activity by the electro-catalysts employed on the cathode and anode electrodes. These features help to minimise the impedance of the electrolyzer cell and maximise the energy efficiency of the electrolyser cell during operation. High weight percentages of KOH must be employed because the use of lower weight percentages, for example 0 to about 0.2 M aqueous solutions of KOH, results in high impedances in the electrolyser cell, as evidenced by low conductivities between the electrodes, as well as low catalytic activities by the catalysts employed on the electrodes. Unfortunately, 27-32 wt % KOH is also highly corrosive, meaning that it may progressively corrode the components of the electrolyzer, including components in both the electrolysis cells/s that produce the hydrogen and oxygen, and components in the engineering system that supports and manages the cell/s. The engineering system, which may be cumulatively referred to as the ‘cell system’, is the ancillary engineering equipment surrounding the cell/s, including the pipes, pumps, valves, tanks, sensors, or other equipment in, for example, the ‘balance-of-plant’ of the cell. Corrosion of these components and the components of the cell/s, limit the operational lifetime of the electrolyzer. The use of a corrosive liquid electrolyte further constrains the types of materials that may be used in the electrolyzer. Only materials that are strongly resistant to corrosion by 27-32 wt % KOH may be viably used.

A potential solution to the issue of corrosion is to use an inter-electrode separator that incorporates bound, ionizable groups that can transport the ions that must migrate between the electrodes during the electrochemical reaction. If such an inter-electrode separator is sufficiently conductive, it can strongly facilitate the needed ion migration between the electrodes (promoting high conductivity between the electrodes and high catalytic activity at the electrodes) without the need for a conductive and corrosive liquid electrolyte. A poorly conductive, ‘low corrosion’ liquid electrolyte, such as de-ionized water, may be used instead, thereby diminishing corrosion in the electrolyzer. This is the principle of PEM electrolyzers and fuel cells, for example, that use proton (H+) conducting ionomer membranes known as Polymer Electrolyte Membrane (PEM) separators to transport the protons that are exchanged by the electrodes. In the case of an alkaline electrolyzer, such separators would typically include anion exchange membranes (AEMs) that can transport the hydroxide ions during their migration from the hydrogen-generating cathode to the oxygen-generating anode during the electrochemical reaction. Unfortunately, such PEM separators and anion-exchange membranes are generally less conductive than 27-32 wt % KOH.

Accordingly, there is a need for new or improved electro-synthetic or electro-energy cells, cell systems and/or methods of operation that utilise poorly conductive liquid electrolytes in systems that, nevertheless, still provide for a low impedance and preferably a very low impedance. The use of such poorly conductive liquid electrolytes may reduce corrosion in the electro-synthetic or electro-energy cell and cell system.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

### SUMMARY

This Summary is provided to introduce a selection of concepts in a simplified form that are further described below in the Detailed Description. This Summary is not intended to identify all of the key features or essential features of the claimed subject matter, nor is it intended to limit the scope of the claimed subject matter.

In various example aspects, embodiments relate to electro-synthetic or electro-energy cells, supporting cell systems for electro-synthetic or electro-energy cells, and/or methods of operation of electro-synthetic or electro-energy cells or cell systems. Example embodiments relate to electro-synthetic or electro-energy cells and cell systems that display low impedances despite employing poorly conductive liquid electrolytes, and methods of operation of such cells and systems. That is, such embodiments display high conductivities between the electrodes as well as high catalytic activities by the electro-catalysts on the electrodes, despite employing poorly conductive liquid electrolytes. The use of poorly conductive liquid electrolytes in electro-synthetic or electro-energy cells and cell systems normally results in low conductivities between the electrodes as well as low catalytic activities by the catalysts employed on the electrodes; i.e. the use of poorly conductive liquid electrolytes in electro-synthetic or electro-energy cells and cell systems normally results in a high impedance.

In further various example aspects, embodiments relate to electro-synthetic or electro-energy cells, cell systems and/or methods of operation that utilise a poorly conductive liquid electrolyte whilst simultaneously providing a low impedance, as demonstrated by high conductivity between the electrodes as well as high catalytic activities by the electro-catalysts employed on the electrodes. Preferably but not exclusively, the poorly conductive liquid electrolyte is also a low corrosion electrolyte that reduces the rate of corrosion in the cells and cell systems.

In one example aspect, there is provided an electro-synthetic or electro-energy cell comprising a first electrode, a second electrode, and a liquid flow channel between the first electrode and the second electrode, the liquid flow channel being fully occupied by a liquid. The liquid flow channel is positioned between the first electrode and the second electrode, and the liquid flow channel is for supplying a liquid electrolyte to the first electrode and the second electrode. Preferably, the liquid flow channel is a ‘narrow liquid flow channel’ and has a width equal to or less than 0.20 mm, equal to or less than 0.18 mm, equal to or less than 0.16 mm, equal to or less than 0.14 mm, equal to or less than 0.12 mm, equal to or less than 0.10 mm, equal to or less than 0.08 mm, equal to or less than 0.06 mm, equal to or less than 0.04 mm, or equal to or less than 0.02 mm. In another example aspect, the liquid flow channel is fully occupied by a liquid during operation of the cell.

In another example aspect, there is provided an electro-synthetic or electro-energy cell comprising a first electrode, a second electrode, and a liquid flow channel between the first electrode and the second electrode, wherein the liquid flow channel is fully occupied by a ‘poorly conductive liquid electrolyte’. Preferably, the liquid flow channel is a narrow liquid flow channel.

A poorly conductive liquid electrolyte is a liquid electrolyte that is not significantly conductive. In one example, a poorly conductive liquid electrolyte has a specific conductivity of less than or equal to 0.1 S cm⁻¹ at 80 °C. Examples of poorly conductive liquid electrolytes, include, but are not limited to: 0.0-~0.2 M (i.e. 0 to about 0.2 M) aqueous solutions of KOH, NaOH, H₂SO₄, HClO₄, or HCl. While such liquid electrolytes may be alkaline (e.g. KOH, NaOH) or acidic (e.g. H₂SO4, HClO₄, HCl), their low concentrations make them only weakly so. Accordingly, they may also be ‘low corrosion’ electrolytes as defined herein.

In another example aspect, there is provided an electro-synthetic or electro-energy cell comprising a first electrode, a second electrode, and a liquid flow channel between the first electrode and the second electrode, wherein the liquid flow channel is fully occupied by a poorly conductive liquid electrolyte, and wherein the cell is configured to flow a poorly conductive liquid electrolyte through the liquid flow channel. Preferably, the liquid flow channel is a narrow liquid flow channel.

In another example aspect, there is provided an electro-synthetic or electro-energy cell comprising a first electrode, a second electrode, and a liquid flow channel between the first electrode and the second electrode, wherein the liquid flow channel is fully occupied by a poorly conductive liquid electrolyte, and wherein a poorly conductive liquid electrolyte flows through the liquid flow channel. Preferably, the liquid flow channel is a narrow liquid flow channel.

In another example aspect there is provided an electro-synthetic or electro-energy cell, comprising a first electrode, a second electrode, and a liquid flow channel positioned between the first electrode and the second electrode. The liquid flow channel for supplying a liquid electrolyte to the first electrode and the second electrode, and the liquid flow channel being fully occupied with liquid and having a width of 0.20 mm or less. In another example aspect, the liquid flow channel is fully occupied by a liquid during operation of the cell. The liquid flow channel being a narrow flow channel. Preferably, ions are capacitively concentrated at at least one of the first electrode and the second electrode.

In another example aspect, there is provided an electro-synthetic or electro-energy cell comprising a first electrode, a second electrode, and a liquid flow channel between the first electrode and the second electrode, wherein the liquid flow channel is fully occupied by a poorly conductive liquid electrolyte, and wherein ions are capacitively concentrated at at least one of the first electrode and the second electrode. Preferably, the liquid flow channel is a narrow liquid flow channel. In another example aspect, the liquid flow channel is fully occupied by a liquid during operation of the cell. Preferably, ions are capacitively concentrated at least one of the first electrode and the second electrode.

In another example aspect, there is provided an electro-synthetic or electro-energy cell comprising a first electrode, a second electrode, and a liquid flow channel between the first electrode and the second electrode, wherein the liquid flow channel is fully occupied by a poorly conductive liquid electrolyte, and wherein ions are capacitively concentrated at at least one of the first electrode and the second electrode, and wherein the cell is configured to flow a poorly conductive liquid electrolyte through the liquid flow channel. Preferably, the liquid flow channel is a narrow liquid flow channel.

In another example aspect, there is provided an electro-synthetic or electro-energy cell comprising a first electrode, a second electrode, and a liquid flow channel between the first electrode and the second electrode, wherein the liquid flow channel is fully occupied by a poorly conductive liquid electrolyte, and wherein ions are capacitively concentrated at at least one of the first electrode and the second electrode, and wherein a poorly conductive liquid electrolyte flows through the liquid flow channel of the cell. Preferably, the liquid flow channel is a narrow liquid flow channel.

In example aspects, the electro-synthetic cells as disclosed herein, are electrolysis cells, including but not limited to water electrolysis cells (also referred to herein as ‘water electrolyzer’ cells).

In other example aspects, the electro-energy cells as disclosed herein, are fuel cells, including but not limited to hydrogen-oxygen fuel cells.

In other example aspects, despite poorly conductive liquid flowing within the liquid flow channel between the first electrode and the second electrode, the impedance between the first electrode and the second electrode of the cell is low. ‘Low impedance’ may be less than or equal to 1.20 Ω cm², less than or equal to 1.00 Ωcm², less than or equal to 0.80 Ω cm², less than or equal to 0.60 Ω cm², less than or equal to 0.40 Ω cm², less than or equal to 0.35 Ω cm², less than or equal to 0.30 Ω cm², less than or equal to 0.25 Ω cm², less than or equal to 0.20 Ω cm², less than or equal to 0.15 Ω cm², less than or equal to 0.13 Ω cm², less than or equal to 0.11 Ωcm², less than or equal to 0.09 Ω cm², less than or equal to 0.07 Ω cm², less than or equal to 0.05 Ω cm², less than or equal to 0.04 Ω cm², less than or equal to 0.03 Ω cm², less than or equal to 0.02 Ω cm², or less than or equal to 0.01 Ω cm².

Preferably but not exclusively, the poorly conductive liquid electrolyte is also a low corrosion electrolyte. A ‘low corrosion’ liquid electrolyte is a liquid electrolyte that is not significantly corrosive toward common metals, polymers, catalysts, pipes, valves, pumps, tanks, sensors, or other components of an electro-synthetic or electro-energy cell and/or cell system. Preferably, the use of a low corrosion electrolyte avoids or reduces the incidence of significant and/or rapid corrosion of the components of the cell and/or cell system.

In another example aspect, there is provided a method of operating an electro-synthetic or electro-energy cell of the above type, using a poorly conductive electrolyte, such that the cell has a low impedance, the method involving:
(1) Filling the liquid flow channel of the electro-synthetic or electro-energy cell with a highly conductive liquid electrolyte;
(2) Applying and maintaining a potential difference across the electrodes of the cell in order to induce the ions of the highly conductive liquid electrolyte to largely ion-pair with the polarised electrodes, thereby capacitively concentrating the ions at the electrodes de-ionising the liquid electrolyte between the electrodes and leaving it a poorly conductive liquid electrolyte;
(3) Flowing a poorly conductive liquid electrolyte into, out of, or through the liquid flow channel of the cell and within the cell system, whilst simultaneously having a low impedance;
(4) Maintaining a low impedance between the electrodes of the cell (due to the notable local concentrations of ions at the electrodes, from where the ions may readily migrate to the other electrode, which is close nearby, causing resistance to ion migration between the electrodes of the type needed during the electrochemical reaction, to be low).

There is further provided a method of re-generating a preferred embodiment electro-synthetic or electro-energy cell that no longer has low impedance, the method comprising repeating the steps (1) to (4) above.

In another example aspect there is provided a method of operating an electro-synthetic or electro-energy cell, the cell comprising: a first electrode; a second electrode; and a liquid flow channel positioned between the first electrode and the second electrode, the liquid flow channel for supplying a liquid electrolyte to the first electrode and the second electrode, the liquid flow channel being fully occupied with liquid and the liquid flow channel having a width of 0.20 mm or less. The method comprising: filling the flow channel with a liquid electrolyte; and applying a potential difference or a current between the first electrode and the second electrode to cause ions to be capacitively concentrated at at least one of the first electrode and the second electrode. The liquid flow channel being a narrow flow channel. In another example aspect, the method incorporates the step of operating the cell as the poorly conductive liquid electrolyte flows through the flow channel.

In another example aspect there is provided a method of operating an electro-synthetic or electro-energy cell, the cell comprising: a first electrode; a second electrode; and a liquid flow channel positioned between the first electrode and the second electrode, the liquid flow channel for supplying a liquid electrolyte to the first electrode and the second electrode, the liquid flow channel being fully occupied with liquid and the liquid flow channel having a width of 0.20 mm or less. The method comprising: filling the flow channel with a highly conductive liquid electrolyte; applying a potential difference or current between the first electrode and the second electrode; and flowing the poorly conductive liquid electrolyte through the flow channel. Preferably, ions are capacitively concentrated at at least one of the first electrode and the second electrode. The liquid flow channel being a narrow flow channel. In one example the potential difference may be maintained. In another example aspect, the method incorporates the further step of operating the cell as the poorly conductive liquid electrolyte flows through the flow channel.

Preferably but not exclusively, the first electrode is a gas diffusion electrode. Preferably but not exclusively, the first electrode is in direct contact with a body of a first gas that is located on the opposite side of the first electrode to the liquid flow channel. For example, the first gas may be a gas produced by or consumed by the first electrode. Optionally, the first electrode is a gas diffusion electrode that hinders the movement of liquid through the first electrode from the liquid flow channel into a first chamber containing the body of the first gas. Optionally, a gas diffusion layer that halts liquid intrusion, is, additionally, placed between the first electrode and the first chamber containing the body of the first gas.

Preferably but not exclusively, the second electrode is a gas diffusion electrode. Preferably but not exclusively, the second electrode is in direct contact with a body of a second gas that is located on the opposite side of the second electrode to the liquid flow channel. For example, the second gas may a gas produced by or consumed by the second electrode. Optionally, the second electrode is a gas diffusion electrode that hinders the movement of liquid through the second electrode from the liquid flow channel into a second chamber containing the body of the second gas. Optionally, a gas diffusion layer that halts liquid intrusion, is, additionally, placed between the second electrode and the second chamber containing the body of the second gas.

Preferably, prior to or during operation of the cell, the liquid flow channel is filled with a liquid electrolyte and the liquid electrolyte flows into, out of, or through the liquid flow channel. Preferably but not exclusively, the flow of liquid electrolyte into, out of, or through the liquid flow channel is driven by gravity, and/or by pressurising and/or de-pressurising the liquid electrolyte in an external pipe connected to the liquid flow channel. In one example, the liquid electrolyte is, preferably, impelled to flow into, out of, or through the liquid flow channel by a pressure, for example, a gas pressure, applied within an external pipe connected to the liquid flow channel. In another example, the liquid electrolyte is, preferably, impelled to flow into, out of, or through the liquid flow channel by de-pressurising the liquid electrolyte within an external pipe connected to the liquid flow channel, for example by attaching an ejector to the external pipe. An ejector is a device that uses a higher-pressure fluid source (the motive fluid) to generate a region of lower pressure that induces movement in a fluid. An ejector may also be termed an evactor, eductor, aspirator, vacuum ejector, venturi, venturi pump, jet pump, or exhauster. In other examples, the flow of liquid electrolyte into, out of, or through the liquid flow channel may, optionally, be driven by a pump.

Preferably but not exclusively, more than one external pipe may be connected to the liquid flow channel. That is, one or more external pipes may be connected to the liquid flow channel.

In another aspect, there is provided a preferred embodiment cell of the above type wherein, prior to operation or during certain periods of operation of the cell, the liquid electrolyte that flows into, out of, or through the liquid flow channel between the electrodes is, preferably, a highly conductive liquid electrolyte. Examples of highly conductive liquid electrolytes include, but are not limited to, concentrated solutions of strong acids or strong bases, such as, for example, ~0.2-12 M (i.e. about 0.2 to 12 M) aqueous solutions of strong bases (e.g. KOH, NaOH) or strong acids (e.g. H₂SO₄, HClO₄, or HCl). Highly conductive, liquid electrolytes of this type may also be highly corrosive; that is, they may be termed ‘high corrosion’ electrolytes.

Preferably, during operation of the cell, a potential difference is applied across the electrodes of the cell. Preferably but not exclusively, the potential difference applied across the electrodes is more than +0.2 V or less than −0.2 V, more than +0.4 V or less than −0.4 V, more than +0.6 V or less than −0.6 V, more than +0.8 V or less than −0.8 V, more than +1.0 V or less than −1.0 V, more than +1.1 V or less than −1.1 V, more than +1.2 V or less than −1.2 V, more than +1.3 V or less than −1.3 V, more than +1.4 V or less than −1.4 V, more than +1.5 V or less than −1.5 V, more than +1.6 V or less than −1.6 V, more than +1.7 V or less than −1.7 V, more than +1.8 V or less than −1.8 V, more than +1.9 V or less than −1.9 V, more than +2.0 V or less than −2.0 V, more than +2.1 V or less than −2.1 V, more than +2.3 V or less than −2.3 V, more than +2.5 V or less than −2.5 V, more than +3.0 V or less than −3.0 V, or more than +5.0 V or less than −5.0 V.

There is also provided a method of slowing an increase in (i.e. a degradation of) the impedance of an electro-synthetic or electro-energy cell of the above type, wherein that degradation in the impedance derives from a progressive loss of capacitively held ions at the electrodes. The method, preferably but not exclusively, comprises adding replenishment ions to the poorly conductive liquid electrolyte that flows into, out of, or through the liquid flow channel of the cell. For example, instead of using de-ionized water as a poorly conductive liquid electrolyte in an electro-synthetic or electro-energy cell of the above type, a weak solution of KOH, for example 0.1 M KOH, may be used, wherein the additional K⁺ and OH⁻ ions replace K⁺ and OH⁻ ions that are lost during degradation of the cell impedance.

In one aspect, the liquid flow channel also contains a porous spacer, the width of the liquid flow channel in a preferred embodiment electro-synthetic or electro-energy cell of the above type is, preferably but not exclusively, maintained by sandwiching the first electrode and the second electrode against opposite sides of the porous spacer. Preferably, but not exclusively, the porous spacer is imbued with liquid electrolyte and is planar or substantially flat, electrically insulating or non-conductive, and allows liquid to freely pass through it without hindrance or is liquid-permeable. For example, the porous spacer may be a polymer net or a polymer mesh. Preferably but not exclusively, the porous spacer is resistant to corrosion by the liquid electrolyte. Preferably but not exclusively, the porous spacer has a thickness of 0.20 mm or less. Preferably but not exclusively, the porous spacer is a ‘highly porous spacer’ having a porosity (i.e. a void volume) of more than 60%, more than 62%, more than 64%, more than 66%, more than 68%, more than 70%, more than 72%, more than 74%, more than 76%, more than 78%, more than 80%, more than 82%, more than 84%, more than 86%, more than 88%, or more than 90%. Preferably but not exclusively, the first electrode and the second electrode are compressed against opposite sides of the porous spacer with a clamping force of 2 bar or more. In preferred embodiments, the first electrode and the second electrode are compressed against the porous spacer with a clamping force of 2 bar or more, 3 bar or more, 5 bar or more, 7 bar or more, 9 bar or more, 10 bar or more, 12 bar or more, 14 bar or more, 15 bar or more, 20 bar or more, 25 bar or more, 30 bar or more, 35 bar or more, or 50 bar or more.

In another aspect, the electro-synthetic or electro-energy cell is, preferably, configured so that its liquid flow channel also contains a specific class of porous spacer known as a ‘porous capillary spacer’. ‘Porous capillary spacers’ are defined in International Patent Publication Nos. WO2022056603, WO2022056604, WO2022056605, and WO2022056606, all of which are hereby incorporated by reference. Preferably but not exclusively, the porous capillary spacer is imbued with liquid electrolyte.

In one example, the liquid flow channel contains a single porous capillary spacer. Preferably but not exclusively, the porous capillary spacer is imbued with liquid electrolyte and has a width of 0.20 mm or less. Preferably but not exclusively, the first electrode and the second electrode are compressed against the single porous spacer with a clamping force of 2 bar or more. Preferably, liquid electrolyte passing into, out of, or through the liquid flow channel is constrained by the capillary forces of the single porous capillary spacer to largely remain in the liquid flow channel.

In preferred embodiments, the first electrode and the second electrode are compressed against the porous capillary spacer with a clamping force of 2 bar or more, 3 bar or more, 5 bar or more, 7 bar or more, 9 bar or more, 10 bar or more, 12 bar or more, 14 bar or more, 15 bar or more, 20 bar or more, 25 bar or more, 30 bar or more, 35 bar or more, or 50 bar or more.

In other examples in which the liquid flow channel contains a single porous capillary spacer, preferably but not exclusively, the single porous capillary spacer extends outside of, and beyond the liquid flow channel. Preferably, liquid electrolyte flows into or out of the liquid flow channel, by flowing along and within those portions of the single porous capillary spacer located outside of the liquid flow channel. Preferably, the liquid electrolyte is constrained by the capillary forces to largely remain within (but flow along) those portions of the single porous capillary spacer located outside of the liquid flow channel. Such portions of the single capillary spacer located outside of the liquid flow channel may thereby, effectively, act as ‘capillary pipelines’ within which liquid electrolyte may flow to or from the liquid flow channel and, from there, into, out of, or through the liquid flow channel.

In further examples, at least one porous capillary spacer, for example two or more porous capillary spacers, preferably, may be present in the liquid flow channel either partially or fully. The two or more porous capillary spacers in the liquid flow channel may touch, abut, border on, adjoin, neighbour, or be adjacent to each other.

Preferably but not exclusively, the at least one porous capillary spacer in the liquid flow channel, extends outside of, and beyond the liquid flow channel. Preferably, liquid electrolyte flows into or out of the liquid flow channel, by flowing along and within those portions of the at least one porous capillary spacer located outside of the liquid flow channel. Preferably, the liquid electrolyte is constrained by the capillary forces to largely remain within (but flow along) the portions of the at least one porous capillary spacer located outside of the liquid flow channel. Such portions of the at least one porous capillary spacer located outside of the liquid flow channel may thereby, effectively, act as ‘capillary pipelines’ within which liquid electrolyte may flow to or from the liquid flow channel and, from there, into, out of, or through the liquid flow channel.

In further examples, one or more such ‘capillary pipelines’ located outside of the liquid flow channel may be in fluid communication with one or more porous capillary spacers within the liquid flow channel. Preferably but not exclusively, the liquid flow channel contains at least one porous capillary spacer. Preferably but not exclusively, the at least one porous capillary spacer in the liquid flow channel forms part of and is contiguous with a porous capillary spacer located outside of the liquid flow channel that provides a capillary pipeline to or from the liquid flow channel. For example, one, two, three, or more porous capillary spacers may be in the liquid flow channel, with each porous capillary spacer in the liquid flow channel forming part of and being contiguous with a porous capillary spacer located outside of the liquid flow channel that provides a capillary pipeline to or from the liquid flow channel.

In other examples, liquid electrolyte, preferably, flows via one or more capillary pipelines located outside of the liquid flow channel, to or from the liquid flow channel, and thereby into, out of, or through the liquid flow channel. For example, one, two, three, or more capillary pipelines may be in fluid communication with the liquid flow channel, with liquid electrolyte flowing via the one, two, three, or more capillary pipelines into, out of, or through the liquid flow channel. In such examples, the capillary pipelines may be separate to, and non-contiguous with porous capillary spacers present within the liquid flow channel. In still further examples, there may be no porous capillary spacers within the liquid flow channel whatsoever, wherein liquid flowing to or from the liquid flow channel, and thereby into, out of, or through the liquid flow channel, does so along the capillary pipelines that are located outside of the liquid flow channel but are in fluid communication with the liquid flow channel.

In the above examples, liquid electrolyte is, preferably but not exclusively, induced by capillary action to flow along and within the porous capillary spacers, including the porous capillary spacers that form capillary pipelines. Optionally, other effects such as diffusion or osmosis may, alternatively or additionally, induce movement of the liquid electrolyte along and within the porous capillary spacers, including the porous capillary spacers that form capillary pipelines.

In further examples, despite the influence of capillary action, liquid electrolyte may, nevertheless, still be induced to flow into, out of, or through the liquid flow channel under the additional impetus of gravity, and/or by pressurising or de-pressurising the liquid electrolyte, as described earlier. The flow of liquid electrolyte created in such cases may oppose the direction of flow induced by the capillary action of the at least one porous capillary spacer involved.

Preferably, the porous spacer or porous capillary spacer is manufactured from an electrically insulating, i.e. non-conductive, material, including but are not limited to various types, or combinations of types, or hybrids of different types of: PVDF, PTFE, tetrafluoroethylene, fluorinated polymers of various types; polyimides, polyamides, nylon, nitrogen-containing materials of various types; glass fibre, silicon-containing materials of various types; polyvinyl chloride, chloride-containing polymers of various types, cellulose acetate, cellulose nitrate, cellophane, ethyl-cellulose, cellulose-containing materials of various types; polycarbonate, carbonate-containing materials of various types; polyethersulfone, polysulfone, polyphenylsulfone, sulfone-containing materials of various types; polyphenylene sulphide, sulphide-containing materials of various types; polypropylene, polyethylene, polyolefins, olefin-containing materials of various types; asbestos, titanium-based ceramics, zirconium-based ceramics, ceramic materials of various types; polyvinyl chloride, vinyl-based materials of various types; rubbers of various types; or porous battery separators of various types; or clays of various types.

In another aspect, a wide range of liquid electrolytes may, preferably but not exclusively be used, outside of those involving strong acids or bases, including but not limited to:
water containing one or more dissolved ions, such as, but not limited to: 0-14 M concentrations of Na⁺, K⁺, Ca²⁺, Mg²⁺, OH⁻, SO₄²⁻, HSO₄⁻, Cl⁻, NO₃⁻, ClO₄⁻, phosphates (including HPO₄⁻), carbonates (including HCO₃⁻), PF₆⁻, BF₄⁻, (CF₃SO₂)₂N⁻, or polyelectrolytes that contain polymers with functional groups, such as, but not limited to polystyrene sulfonate, DNA, polypeptides;
non-aqueous liquids containing solutes, such as, but not limited to propylene carbonate or dimethoxyethane or propionitrile liquids containing solutes such as, but not limited to, LiClO₄, or Bu₄NPF₆; and
conductive liquids, such ionic liquids comprising of alkyl-substituted as, but not limited to ambient temperature molten salts or ammonium, imidazolium, or pyridinium cations paired with suitable anions.

In another aspect, there is provided an electro-synthetic water electrolysis cell for producing hydrogen and oxygen from water, that utilises a poorly conductive liquid electrolyte whilst still having a low impedance.

In another aspect, there is provided an electro-energy fuel cell for producing electrical energy from hydrogen gas and oxygen gas, that utilises a poorly conductive liquid electrolyte whilst still having a low impedance.

### BRIEF DESCRIPTION OF THE FIGURES

Illustrative embodiments will now be described solely by way of non-limiting examples and with reference to the accompanying figures. Various example embodiments will be apparent from the following description, given by way of example only, of at least one preferred but non-limiting embodiment, described in connection with the accompanying figures.

FIG. 1 depicts, in schematic form, a preferred example embodiment electro-synthetic or electro-energy cell.

FIG. 2 depicts, in schematic form, the liquid flow channel and two electrodes of a preferred example embodiment electro-synthetic or electro-energy cell, with external piping and ancillary engineering equipment, comprising part of the ‘cell system.’ FIG. 3 depicts, in schematic form, the liquid flow channel and two electrodes of a preferred example embodiment electro-synthetic or electro-energy cell, during the ‘cell startup’ phase of operation.

FIG. 4 depicts, in schematic form, the liquid flow channel and two electrodes of a preferred example embodiment electro-synthetic or electro-energy cell, during a catastrophic ‘cell failure’.

FIG. 5 depicts, in schematic form, the liquid flow channel and two electrodes of a preferred example embodiment electro-synthetic or electro-energy cell, during the ‘cell regeneration phase of returning a failed cell to full operation.

FIG. 6 depicts, in schematic form, the liquid flow channel and two electrodes of a preferred example embodiment electro-synthetic or electro-energy cell, during ‘cell degradation’ leading to progressive ‘cell failure’.

FIG. 7 schematically depicts, in cross-section, a preferred example embodiment electro-synthetic or electro-energy cell containing a single porous capillary spacer in a liquid flow channel, that: (a) fully occupies the liquid flow channel, or (b) partially occupies the liquid flow channel.

FIG. 8 schematically depicts, in cross-section, a preferred example embodiment electro-synthetic or electro-energy cell with multiple porous capillary spacers occupying the liquid flow channel, wherein the liquid flow channel is in fluid communications with three capillary pipelines.

FIG. 9 schematically depicts, in cross-section, a preferred example embodiment electro-synthetic or electro-energy cell with a single porous capillary spacer occupying the liquid flow channel, either fully (a) or partially (b).

### DETAILED DESCRIPTION

The following modes, features, or aspects, given by way of example only, are described to provide a more precise understanding of the subject matter of a preferred embodiment or embodiments.

### Definitions

A ‘reactant’ is a chemical material that is consumed during an electrochemical reaction.

A ‘product’ is a chemical material that is produced during an electrochemical reaction.

A ‘liquid electrolyte’ is a liquid containing dissolved ions that has the capacity to conduct electricity.

‘Room temperature’is defined here as 21 °C.

An ‘electro-energy cell’ is an industrial electrochemical cell that generates substantial quantities of electrical power continually or continuously, during operation, over indefinite periods of time, for use outside of the cell. Electro-energy cells may require a constant external supply of reactants during operation. The products of the electrochemical reaction may also be constantly removed from such cells during operation.

An ‘electro-synthetic cell’ is an industrial electrochemical cell that converts substantial quantities of one or more reactants into products continually or continuously, during operation, over indefinite periods of time, for use outside the cell. The reactants or products may be in the form of a gas, liquid, or solid. An electro-synthetic cell requires a constant supply of reactants and a constant removal of products during operation. Electro-synthetic cells may generally further require a constant input of electrical energy during operation.

Electro-synthetic and electro-energy cells differ from other types of electrochemical cells, such as batteries, flow batteries, sensors, capacitors and the like, in that they do not incorporate within the cell body all/some of the reactants they require to operate, nor all/some of the products they generate during operation. These may be, instead, constantly brought in from, or removed to the outside of the cell during operation. For example, electro-synthetic cells are distinguished from galvanic cells in that galvanic cells store their reactants and products within the cell body. Similarly, while some electrochemical sensors may consume reactants and generate products in limited quantities during the sensing operation, all/some of these are stored within the cell body itself.

A ‘liquid-gas’ cell is an electrochemical cell that has at least one liquid-phase reactant or product and at least one gas-phase reactant or product. An electro-synthetic or electro-energy cell may also be a liquid-gas cell. An example of an electro-synthetic liquid-gas cell is a water electrolyser cell that converts liquid-phase water into hydrogen gas at the cathode and oxygen gas at the anode. An example of an electro-energy liquid-gas cell is a hydrogen-oxygen fuel cell that converts gas-phase hydrogen and gas-phase oxygen into liquid-phase water.

The ‘cell system’ of an electro-synthetic or electro-energy cell is defined as the ancillary engineering equipment surrounding the cell, including the piping, pumps, valves, tanks, sensors, and other equipment in, for example, the balance-of-plant of the cell.

The ‘energy efficiency’ of an electro-synthetic or electro-energy cell or system is defined here as the net energy present within a single unit output of the main chemical product, divided by the net energy consumed by the cell or the system to produce the same unit output of that chemical product, expressed as a percentage.

A ‘cell stack’ is defined as an assembly of two or more cells, wherein the cells are stacked adjacent to or abutting each other along a single dimensional axis.

Cell stacks may take the form of a ‘filter-press’ arrangement, which is defined as a cell stack wherein the cells are substantially flat and compressed against each other between endplates during its assembly and/or operation.

A ‘liquid flow channel’ is defined as a channel, positioned between electrodes of a cell, along which liquid electrolyte flows to the electrodes in an electro-energy or electro-synthetic cell. A liquid flow channel may occupy the entire volume between the electrodes of the cell. Unless stated otherwise, the term ‘liquid flow channel’ indicates that the channel is fully occupied, fully filled, filled, completely filled, totally filled or full with the liquid electrolyte (i.e. the liquid flow channel contains only liquid electrolyte, that is, there is nothing but liquid electrolyte within the flow channel, for example, there is no porous spacer or other material in the flow channel).

A ‘narrow liquid flow channel’ is defined as a liquid flow channel that has a width equal to or less than 0.20 mm, equal to or less than 0.18 mm, equal to or less than 0.16 mm, equal to or less than 0.14 mm, equal to or less than 0.12 mm, equal to or less than 0.10 mm, equal to or less than 0.08 mm, equal to or less than 0.06 mm, equal to or less than 0.04 mm, or equal to or less than 0.02 mm.

A ‘separator’ is a membrane, ionomer, diaphragm, or similar material, that may be placed between the electrodes of an electro-synthetic or electro-energy cell, and allows ions to flow between the electrodes (i.e. allowing the electrochemical reaction to occur) whilst simultaneously strongly hindering reactants and/or products (e.g. gases) that are present in one half-cell on one side of the separator, from passing through the separator to the other half-cell on the other side of the separator. Thus, a separator is also an inter-electrode separator.

A ‘spacer’ or ‘porous spacer’ is defined herein as a substantially flat, planar, porous material that, when imbued with liquid electrolyte may be used as a separator in an electro-energy or electro-synthetic cells, such as a porous membrane or porous diaphragm, wherein the volume of the spacer or porous spacer comprises at least 15% void volume and liquid electrolyte may flow into and fill the void volume. That is, a ‘spacer’ or ‘porous spacer’ as defined herein is a potential separator that is electrically insulating or non-conductive, and allows liquid to freely pass through it without hindrance or is liquid-permeable, and that has a porosity of more than 15%, wherein liquid electrolyte may flow into and fill the porosity. A ‘spacer’ or ‘porous spacer’ may, typically, include a porous membrane, a porous diaphragm or a substantially flat, planar porous structure such as, for example, a polymer net or a polymer mesh, but generally not an ionomer membrane, such as, for example, Nafion membranes or anion exchange membranes, which are usually considered non-porous in their structure.

A ‘highly porous spacer’ is defined as a spacer or porous spacer that is substantially porous; that is, it is a spacer or porous spacer whose volume comprises at least 60% void volume, wherein liquid electrolyte may flow into and fill the void volume within the spacer. That is, a ‘highly porous spacer’ as defined herein is a spacer or porous spacer that has a porosity of more than 60%, wherein liquid electrolyte may flow into and fill the porosity.

A ‘porous capillary spacer’ is a specific example of a spacer, also as defined in International Patent Publication Nos. WO2022056603, WO2022056604, WO2022056605, and WO2022056606, all of which are hereby incorporated by reference. A porous capillary spacer is a porous structure that may draw in and confine a liquid within it by a capillary effect. The liquid may be induced to move through the porous structure, whilst confined within the porous structure, by a capillary effect, or by other effects, including but not limited to diffusion or osmosis. The porous capillary spacer, imbued with liquid electrolyte, may be placed between the electrodes of an electro-synthetic or electro-energy cell, but may also extend beyond the extent (i.e. ends or edges) of the electrodes.

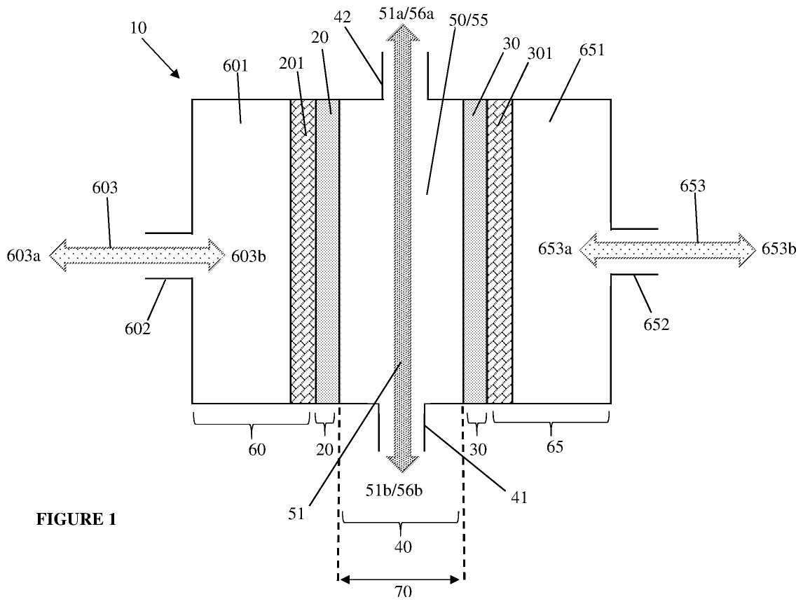

A ‘capillary pipeline’ is herein defined as a portion of a porous capillary spacer, or a separate porous capillary spacer, that may be imbued with liquid electrolyte, that is located outside of a liquid flow channel (for example of the type of liquid flow channel 40 described in FIG. 1 and associated text), and through which liquid, confined within the capillary pipeline, but able to flow along the capillary pipeline, moves into or out of the liquid flow channel. That is, a ‘capillary pipeline’ is a portion of a porous capillary spacer, that may be imbued with liquid electrolyte, that lies outside of a liquid flow channel, or is a separate porous capillary spacer positioned outside of a liquid flow channel, but is in fluid, liquid communication with the liquid flow channel, or with a porous spacer or porous capillary spacer, that may be imbued with liquid electrolyte, if present within the liquid flow channel. In one example, a porous capillary spacer, that may be imbued with liquid electrolyte, may be placed between the electrodes of an electro-synthetic or electro-energy cell, but may extend beyond the extent (i.e. ends or edges) of the electrodes, and in this situation a portion of the porous capillary spacer, that may be imbued with liquid electrolyte, that extends beyond the extent (i.e. ends or edges) of the electrodes can be termed a capillary pipeline. Alternatively, the capillary pipeline can be an electrolyte-imbued separate porous membrane, porous diaphragm, or similar porous structure, of the same material as the porous capillary spacer (if used at all), or a different material or structure as the porous capillary spacer (if used at all), but placed outside the extent (i.e. ends or edges) of the electrodes and placed adjacent to, near or abutting the ends of the porous capillary spacer (if used at all) so as to provide fluid communication between the electrolyte-imbued capillary pipeline and the electrolyte-imbued porous capillary spacer, or otherwise placed adjacent to, near or at the ends of the liquid flow channel (for example if no porous capillary spacer is used in the liquid flow channel).

Ions are defined as being ‘capacitively concentrated’ at an electrode if ions are accumulated at or about the electrode by a capacitive effect. That is, ions ‘capacitively concentrate’ at an electrode if ion-pairing occurs between the ions and the charged electrode and this results in a high local concentration of ions being present at the electrode. Ion pairing may occur if the charge on the ions is opposite to the charge on the electrode, causing the ions to be attracted to the electrode and held by or near to the electrode. Capacitance is the capacity of a material object or device to store electric charge. It is measured by the change in charge in response to a difference in electric potential, expressed as the ratio of those quantities. Several means are available to confirm that ions have been capacitively concentrated at or about an electrode, including the following: (i) the electrode and materials about it may be subjected to chemical analysis to determine whether an increased concentration of ions can be detected following a process for capacitive concentration (as described in Example 3 below), (ii) the capacitance of the electrode can be measured and be shown to have increased during the capacitive concentration process, (iii) the liquid solution passing the electrode can be demonstrated to have become depleted of ions due to and during the capacitive concentration process (for example by measuring the conductance of the liquid solution before and after passing through the liquid flow channel, or (iv) an electrode that has previously been subjected to capacitive concentration of ions may be deliberately capacitively discharged to thereby release the accumulated ions into a passing liquid electrolyte, with accompanying demonstration that, in so doing, the conductance of the electrolyte increases.

The term ‘liquid electrolyte’ is defined to mean a liquid that is present and used in an electro-synthetic or electro-energy cell. In some cells, the liquid may be highly conductive (such as, for example, 1 M KOH, 6 M NaOH, 1 M H₂SO₄, or 4.5 M HCl). In other cells the liquid may be poorly conductive (such as, for example, de-ionized water).

A ‘high corrosion’ liquid electrolyte is defined as a liquid electrolyte that is significantly corrosive toward common metals, polymers, catalysts, pipes, valves, pumps, tanks, sensors, or other components of an electro-synthetic or electro-energy cell and cell system. Examples of high corrosion liquid electrolytes include liquid electrolytes that contain high molarities of ions deriving from strong acids or bases, such as, for example, ~0.2-12.0 M (i.e. about 0.2 to 12.0 M) aqueous solutions of KOH, NaOH, H₂SO₄, HClO₄, or HCl.

A ‘highly conductive’ liquid electrolyte is defined as a liquid electrolyte that is significantly conductive. In one example, a highly conductive liquid electrolyte may have a specific conductivity of more than 0.1 S cm⁻¹ at 80 °C. Examples of highly conductive liquid electrolytes include liquid electrolytes that contain high molarities of ions deriving from strong acids or bases, such as, for example, ~0.2-12.0 M (i.e. about 0.2 to 12.0 M) aqueous solutions of KOH, NaOH, H₂SO₄, HClO₄, or HCl.

A ‘low corrosion’ liquid electrolyte is defined as a liquid electrolyte that is not significantly corrosive toward common metals, polymers, catalysts, pipes, valves, pumps, tanks, sensors, or other components of an electro-synthetic or electro-energy cell and/or cell system. Preferably, the use of a low corrosion electrolyte avoids or reduces the incidence of significant and/or rapid corrosion of the components of the cell and/or cell system. Examples of low corrosion liquid electrolytes include liquid electrolytes that contain low molarities of ions deriving from strong acids or bases, such as, for example, 0.0-~0.2 M (i.e. 0 to about 0.2 M) aqueous solutions of KOH, NaOH, H₂SO₄, HClO₄, or HCl.

A ‘poorly conductive’ liquid electrolyte is defined as a liquid electrolyte that is not significantly conductive. In one example, a poorly conductive liquid electrolyte may have a specific conductivity of less than or equal to 0.1 S cm⁻¹ at 80° C. Examples of poorly conductive liquid electrolytes include liquid electrolytes that contain low molarities of ions deriving from strong acids or bases, such as, for example, 0.0-~0.2 M (i.e. 0 to about 0.2 M) aqueous solutions of KOH, NaOH, H₂SO₄, HClO₄, or HCl. While such liquid electrolytes may be alkaline (e.g. KOH, NaOH) or acidic (e.g. H₂SO₄, HClO₄, HCl), their low concentrations make them only weakly so. Accordingly, they may also be ‘low corrosion’ electrolytes as defined herein.

A ‘highly conductive, high corrosion’ liquid electrolyte is defined as a liquid electrolyte that is both significantly conductive and significantly corrosive toward common metals, polymers, catalysts, pipes, valves, pumps, tanks, sensors, or other components of an electro-synthetic or electro-energy cell and cell system. Examples of highly conductive, high corrosion liquid electrolytes include liquid electrolytes that contain high molarities of ions deriving from strong acids or bases, such as, for example, ~0.2-12.0 M (i.e. about 0.2 to 12.0 M) aqueous solutions of KOH, NaOH, H₂SO₄, HClO₄, or HCl.

A ‘poorly conductive, low corrosion’ liquid electrolyte is defined as a liquid electrolyte that is both poorly conductive and not significantly corrosive toward common metals, polymers, catalysts, pipes, valves, pumps, tanks, sensors, or other components of an electro-synthetic or electro-energy cell and/or cell system. Examples of poorly conductive, low corrosion liquid electrolytes include liquid electrolytes that contain low molarities of ions deriving from strong acids or bases, such as, for example, 0.0-~0.2 M (i.e. 0 to about 0.2 M) aqueous solutions of KOH, NaOH, H₂SO₄, HClO₄, or HCl.

‘Low impedance’ is characterised by a high conductivity (i.e. a low electrical resistance) between the electrodes of a cell, with high catalytic activity, or promotion thereof, by the electro-catalysts employed on at least one of the cathode and anode electrodes. ‘Low impedance’ is quantitatively defined herein as an effective area specific resistance (ASR) between the electrodes of an electro-synthetic or electro-energy cell of 1.20 Ω cm² or less. Preferably, the electrochemical performance of cell is consistent with an effective ASR between the electrodes of less than or equal to 1.20 Ω cm², less than or equal to 1.00 Ω cm², less than or equal to 0.80 Ω cm², less than or equal to 0.60 Ω cm², less than or equal to 0.40 Ω cm², less than or equal to 0.35 Ω cm², less than or equal to 0.30 Ω cm², less than or equal to 0.25 Ω cm², less than or equal to 0.20 Ω cm², less than or equal to 0.15 Ω cm², less than or equal to 0.13 Ω cm², less than or equal to 0.11 Ω cm², less than or equal to 0.09 Ω cm², less than or equal to 0.07 Ω cm², less than or equal to 0.05 Ω cm², less than or equal to 0.04 Ω cm², less than or equal to 0.03 Ω cm², less than or equal to 0.02 Ω cm², or less than or equal to 0.01 Ω cm².

A ‘low corrosion’ ‘low impedance’ electro-synthetic or electro-energy cell and/or cell system is defined as an electro-synthetic or electro-energy cell and/or cell system that may operate with low impedance when using a low corrosion liquid electrolyte.

### 1. Preferred Embodiments

### 1a. Description of a General Example Cell

The inventors have developed novel electro-synthetic or electro-energy cells and cell systems, and methods of operation thereof, that despite using a poorly conductive liquid electrolyte still has a low impedance. That is, such electro-synthetic or electro-energy cells display high conductivities between the electrodes as well as high catalytic activities by the electro-catalysts employed on the electrodes, despite employing poorly conductive liquid electrolytes. The use of poorly conductive liquid electrolytes in electro-synthetic or electro-energy cells and cell systems normally results in low conductivities between the electrodes as well as low catalytic activities, or promotion thereof, by the catalysts employed on the electrodes; i.e. the use of poorly conductive liquid electrolytes in electro-synthetic or electro-energy cells and cell systems normally results in high impedances. Preferably but not exclusively, the poorly conductive liquid electrolyte is also a low corrosion liquid electrolyte that causes a low rate of corrosion in the cells and cell systems.

FIG. 1 schematically depicts a general example embodiment electro-synthetic or electro-energy cell. The electro-synthetic or electro-energy cell 10 in FIG. 1 comprises a first electrode 20, a second electrode 30, and a liquid flow channel 40 between the first electrode 20 and the second electrode 30. The liquid flow channel 40 is positioned between the first electrode 20 and the second electrode 30, and the liquid flow channel 40 is for supplying a ‘highly conductive’ liquid electrolyte 50, or a ‘poorly conductive’ liquid electrolyte 55 to the first electrode 20 and the second electrode 30. Preferably, the liquid flow channel 40 is a ‘narrow liquid flow channel’ A narrow liquid flow channel, such as the liquid flow channel 40, has a width 70 of equal to or less than 0.20 mm, equal to or less than 0.18 mm, equal to or less than 0.16 mm, equal to or less than 0.14 mm, equal to or less than 0.12 mm, equal to or less than 0.10 mm, equal to or less than 0.08 mm, equal to or less than 0.06 mm, equal to or less than 0.04 mm, or equal to or less than 0.02 mm. Preferably, the liquid flow channel 40 is completely occupied by liquid electrolyte.

As described above, a poorly conductive liquid electrolyte 55 is a liquid electrolyte that is not significantly conductive. In one example, a poorly conductive liquid electrolyte 55 has a specific conductivity of less than or equal to 0.1 S cm⁻¹ at 80 °C. As described above, a highly conductive liquid electrolyte 50 is a liquid electrolyte that is significantly conductive. In one example, a highly conductive liquid electrolyte has a specific conductivity of more than 0.1 S cm⁻¹ at 80 °C.

Examples of highly conductive liquid electrolytes 50 include but are not limited to: ~0.2-12.0 M (i.e. about 0.2 to 12.0 M) aqueous solutions of strong bases or acids such as KOH, NaOH, H₂SO₄, HClO₄, or HCl. Liquid electrolytes 50 of this type are used in many industrial water electrolysis cells, as their highly conductive nature imparts the cells with low impedance. However, due to their strongly alkaline (e.g. KOH, NaOH) or strongly acidic (e.g. H₂SO₄, HClO₄, HCl) nature, such liquid electrolytes 50 may also be highly corrosive (making them ‘high corrosion’ electrolytes as defined above). KOH is known in industry as caustic potash, while NaOH is caustic soda, H₂SO₄ is sulfuric acid, HClO₄ is perchloric acid, and HCl is hydrochloric acid.

Examples of poorly conductive liquid electrolytes 55, include, but are not limited to: 0.0-~0.2 M (i.e. 0 to about 0.2 M) aqueous solutions of KOH, NaOH, H₂SO₄, HClO₄, or HCl. While such liquid electrolytes 55 may be alkaline (e.g. KOH, NaOH) or acidic (e.g. H₂SO₄, HClO4, HCl), their low concentrations make them only weakly so. Accordingly, they may be ‘low corrosion’ electrolytes as defined above. That is, they may avoid significant and rapid corrosion of the components of the cell and cell system.

The inventors have, firstly, found that having a small gap between the electrodes, i.e. a ‘narrow liquid flow channel’ between the electrodes, wherein the liquid flow channel contains only liquid electrolyte and nothing else, may provide for improved (lower) impedance in an electro-synthetic or electro-energy cell. That is, regardless of the liquid electrolyte present in the flow channel, whether it is highly conductive or poorly conductive or something in-between, a ‘narrow liquid flow channel’ may provide for improved (lower) impedance over a less narrow, or wider, liquid flow channel when filled with the same liquid. This is true even when using poorly conductive liquid electrolytes, which may reasonably be expected to display no effect on the impedance when employed in flow channels of differing width. It is believed that this may be, at least in part, due to an improvement in the catalytic activity by the electro-catalysts employed on the cathode and anode electrodes as the flow channel narrows, which, in turn, synergistically provides for a higher conductivity between the electrodes, or vice versa. It is possible that ions within a liquid electrolyte may be more favoured to concentrate nearer to the electrodes as the flow channel becomes narrower due to an increasing influence on the liquid electrolyte, of an interfacial or surface effect (e.g. at a metal-liquid interface or surface). The interfacial or surface effect may include an interfacial or surface static charge effect, an interfacial or surface capacitive effect, an interfacial surface area effect, an interfacial or surface hydrophobic-hydrophilic effect, an interfacial or surface wetting or contact angle effect, or another interfacial or surface effect that becomes more favoured as the flow channel becomes narrower.

Accordingly, in a first example aspect, there is provided an electro-synthetic or electro-energy cell 10 comprising a first electrode 20, a second electrode 30, and a liquid flow channel 40 between the first electrode 20 and the second electrode 30, wherein the liquid flow channel 40 is fully occupied by a highly conductive liquid electrolyte 50 or poorly conductive liquid electrolyte 55. The liquid flow channel 40 is positioned between the first electrode 20 and the second electrode 30, and the liquid flow channel 40 is for supplying a highly conductive liquid electrolyte 50 or a poorly conductive liquid electrolyte 55, to the first electrode 20 and the second electrode 30. Preferably, the liquid flow channel 40 is a narrow liquid flow channel.

The inventors have further developed protocols and means that may, surprisingly, provide for drastically improved impedance even when using poorly conductive electrolyte within a narrow liquid flow channel. The protocols and means are described in section 1b and section 2 below.

Accordingly, in another example aspect, there is provided an electro-synthetic or electro-energy cell 10 comprising a first electrode 20, a second electrode 30, and a liquid flow channel 40 between the first electrode 20 and the second electrode 30, wherein the liquid flow channel 40 is fully occupied by a poorly conductive liquid electrolyte 55. Preferably, the liquid flow channel 40 is a narrow liquid flow channel.

In another example aspect, there is provided an electro-synthetic or electro-energy cell 10 comprising a first electrode 20, a second electrode 30, and a liquid flow channel 40 between the first electrode 20 and the second electrode 30, wherein the liquid flow channel 40 is fully occupied by a poorly conductive liquid electrolyte 55, and wherein the cell 10 is ‘configured’ to flow a poorly conductive liquid electrolyte 55 through the liquid flow channel 40. Examples describing how a cell may be ‘configured’ to flow a poorly conductive liquid electrolyte 55 through the liquid flow channel 40, are provided in section 1c below. Preferably, the liquid flow channel 40 is a narrow liquid flow channel.

In another example aspect, there is provided an electro-synthetic or electro-energy cell 10 comprising a first electrode 20, a second electrode 30, and a liquid flow channel 40 between the first electrode 20 and the second electrode 30, wherein the liquid flow channel 40 is fully occupied by a poorly conductive liquid electrolyte 55, and wherein a poorly conductive liquid electrolyte 55 flows through the liquid flow channel 40. Preferably, the liquid flow channel 40 is a narrow liquid flow channel.

The protocols and means developed by the inventors, that may provide for surprisingly drastically improved impedances, even when using poorly conductive electrolyte within a narrow liquid flow channel, involve capacitively concentrating ions at the electrodes in the cell. The capacitive concentrating methods and operations are described in section 1b and section 2 below.

In a further example aspect there is provided an electro-synthetic or electro-energy cell 10, comprising a first electrode 20, a second electrode 30, and a liquid flow channel 40 positioned between the first electrode 20 and the second electrode 30. The liquid flow channel 40 for supplying a highly conductive liquid electrolyte 50 or a poorly conductive liquid electrolyte 55 to the first electrode 20 and the second electrode 30, and the liquid flow channel 40 being a narrow flow channel. Preferably, ions are capacitively concentrated at at least one of the first electrode 20 and the second electrode 30. The term ‘capacitively concentrated’ is described in detail in section 2 below.

In another example aspect, there is provided an electro-synthetic or electro-energy cell 10 comprising a first electrode 20, a second electrode 30, and a liquid flow channel 40 between the first electrode 20 and the second electrode 30, wherein the liquid flow channel 40 is fully occupied by a poorly conductive liquid electrolyte 55, and wherein ions are capacitively concentrated at at least one of the first electrode 20 and the second electrode 30. Preferably, the liquid flow channel 40 is a narrow liquid flow channel. The term ‘capacitively concentrated’is described in detail in section 2 below.

In another example aspect, there is provided an electro-synthetic or electro-energy cell 10 comprising a first electrode 20, a second electrode 30, and a liquid flow channel 40 between the first electrode 20 and the second electrode 30, wherein the liquid flow channel 40 is fully occupied by a poorly conductive liquid electrolyte 55, and wherein ions are capacitively concentrated at at least one of the first electrode 20 and the second electrode 30, and wherein the cell is configured to flow a poorly conductive liquid electrolyte 55 through the liquid flow channel 40. Preferably, the liquid flow channel 40 is a narrow liquid flow channel. Examples describing how a cell may be ‘configured’ to flow a poorly conductive liquid electrolyte 55 through the liquid flow channel 40, are provided in section 1c below. The term ‘capacitively concentrated’ is described in detail in section 2 below.

In another example aspect, there is provided an electro-synthetic or electro-energy cell 10 comprising a first electrode 20, a second electrode 30, and a liquid flow channel 40 between the first electrode 20 and the second electrode 30, wherein the liquid flow channel 40 is fully occupied by a poorly conductive liquid electrolyte 55, and wherein ions are capacitively concentrated at at least one of the first electrode 20 and the second electrode 30, and wherein a poorly conductive liquid electrolyte 55 flows through the liquid flow channel 40. Preferably, the liquid flow channel 40 is a narrow liquid flow channel. The term ‘capacitively concentrated’is described in detail in section 2 below.

In a preferred embodiment, there is provided a cell 10, wherein, when a potential difference is applied across the first electrode 20 and the second electrode 30, a poorly conductive liquid electrolyte 55 flows into, out of, or through the flow channel 40 between the first electrode 20 and the second electrode 30 in a first direction 56a or a second direction 56b. Preferably but not exclusively, the flow of the poorly conductive liquid electrolyte 55 into, out of, or through the flow channel 40 is driven by gravity, and/or by pressurising or de-pressurising the liquid electrolyte 55 in the external first pipe 42 or the external second pipe 41 in fluid communication with the flow channel 40, as described in section 1c below.

In example aspects, the electro-synthetic cells 10 as disclosed herein, are electrolysis cells, including but not limited to water electrolysis cells (also referred to herein as ‘water electrolyzer’ cells).

In other example aspects, the electro-energy cells 10 as disclosed herein, are fuel cells, including but not limited to hydrogen-oxygen fuel cells.

In other example aspects, despite poorly conductive liquid electrolyte 55 flowing within the flow channel 40 of the electro-synthetic or electro-energy cell 10, the impedance between the electrodes 20 and 30 of the cell is low, as demonstrated by high conductivity between the electrodes as well as high catalytic activities, or promotion thereof, by the electro-catalysts employed on the electrodes. As described above, ‘low impedance’ may be quantified as being less than or equal to 1.20 Ωcm², less than or equal to 1.00 Ω cm², less than or equal to 0.80 Ω cm², less than or equal to 0.60 Ω cm², less than or equal to 0.40 Ω cm², less than or equal to 0.35 Ω cm², less than or equal to 0.30 Ω cm², less than or equal to 0.25 Ω cm², less than or equal to 0.20 Ω cm², less than or equal to 0.15 Ω cm², less than or equal to 0.13 Ω cm² , less than or equal to 0.11 Ω cm², less than or equal to 0.09 Ω cm², less than or equal to 0.07 Ω cm², less than or equal to 0.05 Ω cm², less than or equal to 0.04 Ω cm², less than or equal to 0.03 Ω cm², less than or equal to 0.02 Ω cm², or less than or equal to 0.01 Ω cm².

Preferably, but not exclusively, the poorly conductive liquid electrolyte 55 is also a low corrosion electrolyte. As described above, a ‘low corrosion’ liquid electrolyte is a liquid electrolyte that is not significantly corrosive toward common metals, polymers, catalysts, pipes, valves, pumps, tanks, sensors, or other components of an electro-synthetic or electro-energy cell and/or cell system. Preferably, the use of a low corrosion electrolyte avoids or reduces the incidence of significant and/or rapid corrosion of the components of the cell and/or cell system.

### 1b. General Method of Operating a General Example Cell

In another example aspect, there is provided a method of operating an electro-synthetic or electro-energy cell 10 of the above described type, using a poorly conductive electrolyte 55, such that the cell 10 has a low impedance, the method involving:
(1) Filling the liquid flow channel 40 of the electro-synthetic or electro-energy cell 10 with a highly conductive liquid electrolyte 50;
(2) Applying and maintaining a potential difference (voltage difference) across the electrodes 20 and 30 of the cell 10 in order to induce the ions of the highly conductive liquid electrolyte 50 to largely ion-pair with the polarised electrodes 20 and/or 30, thereby capacitively concentrating the ions at the electrodes;
(3) Flowing a poorly conductive liquid electrolyte 55 into, out of, or through the liquid flow channel 40 of the cell 10 and within the cell system, whilst simultaneously having a low impedance (due to the notable local concentrations of ions at the electrodes 20 and/or 30, from where the ions may readily migrate to the other electrode 20 or 30 respectively, which is close nearby, causing resistance to ion migration between the electrodes 20 and 30, to be low, and promoting high catalytic activity by the electro-catalysts at at least one of the electrodes);
(4) Maintaining a low impedance between the electrodes 20 and 30 of the cell 10 (due to the notable local concentrations of ions at the electrodes 20 and/or 30, from where the ions may readily migrate to the other electrode 20 or 30 respectively, which is close nearby, causing resistance to ion migration between the electrodes 20 and 30, to be low, and promoting high catalytic activity by the electro-catalysts at at least one of the electrodes).

There is further provided a method of re-generating a preferred embodiment electro-synthetic or electro-energy cell 10 that no longer has low impedance, the method comprising repeating the steps (1) to (4) above.

### 1c. Non-Limiting Examples Illustrating how a General Example Cell may be “Configured” to Flow a Liquid Electrolyte Through a Liquid Flow Channel

Preferably, prior to, during or after operation of the cell 10, the liquid flow channel 40 (herein also referred to as the flow channel 40) is filled with a liquid electrolyte 50, 55 and the liquid electrolyte 50, 55 flows into, out of, or through the flow channel 40 in a direction 51, being either a first direction 51a/56a or a second direction 51b/56b. Preferably but not exclusively, the flow of liquid electrolyte 50, 55 into, out of, or through the flow channel 40 in one of the directions 51a/56a or 51b/56b, is driven by gravity, and/or by pressurising or de-pressurising the liquid electrolyte 50, 55 in an external first pipe 42 or an external second pipe 41 in fluid communication with the flow channel 40. The flow of liquid electrolyte 50, 55 may be driven by pressurising the liquid electrolyte 50, 55 in the external first pipe 42 or the external second pipe 41 in fluid communication with the flow channel 40, by, for example, connecting a pump to the external first pipe 42 or the external second pipe 41. The flow of liquid electrolyte 50, 55 may, alternatively, be driven by de-pressurising the liquid electrolyte 50, 55 in the external first pipe 42 or the external second pipe 41 in fluid communication with the flow channel 40, by, for example, connecting an ejector to the external first pipe 42 or the external second pipe 41. An ejector, is a device that uses a higher-pressure fluid source (the motive fluid) to generate a region of lower pressure that induces movement in a fluid. An ejector may also be termed an evactor, eductor, aspirator, vacuum ejector, venturi, venturi pump, jet pump, or exhauster.

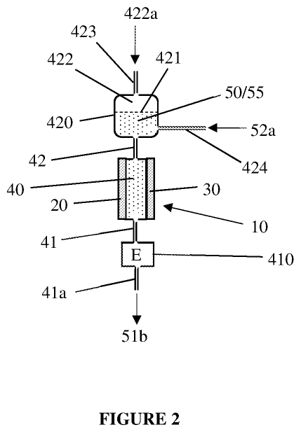

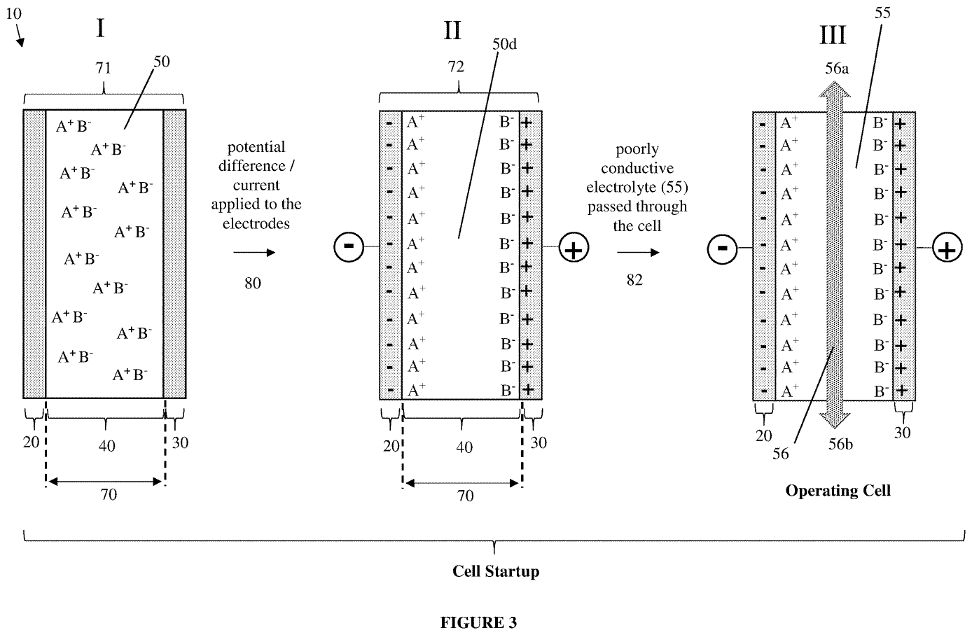

FIG. 2 schematically illustrates non-limiting examples of these alternatives. FIG. 2 depicts only the flow channel 40 and the first electrode 20 and the second electrode 30 of the cell 10 with the external first pipe 42 and the external second pipe 41 connected to the flow channel 40. The external first pipe 42 and the external second pipe 41 comprise part of the ‘cell system’, which involves the piping, pumps, and the ancillary engineering equipment that supports and surrounds the cell.

FIG. 2, in part, illustrates the case where the flow of liquid electrolyte 50, 55 into, out of, or through the flow channel 40 is driven by gravity. In this case:
(1) liquid electrolyte 50, 55 may pass into the flow channel 40 from the top, via external first pipe 42, under the influence of gravity;
(2) liquid electrolyte 50, 55 may passed out of the flow channel 40 from the bottom, via external second pipe 41, under the influence of gravity;
(3) liquid electrolyte 50, 55 may pass through the flow channel 40 by entering at the top via external first pipe 42 and exiting at the bottom via external second pipe 41, under the influence of gravity.

FIG. 2, in part, also illustrates the additional or alternative case where the flow of liquid electrolyte 50, 55 into, out of, or through the flow channel 40 is driven by pressurising the liquid electrolyte 50, 55 in an external pipe. In this case:
(4) External first pipe 42 has a pressure vessel 420 connected, wherein the pressure vessel 420 contains liquid electrolyte 50, 55, and a pressurised gas 422. The liquid level in pressure vessel 420 is depicted as level 421. Pressurised gas 422 enters the pressure vessel 420 via a gas inlet pipe 423 in direction 422a. The liquid electrolyte 50, 55 enters the pressure vessel 420 via a liquid inlet pipe 424 in direction 52a. The liquid electrolyte 50, 55 within pressure vessel 420 is pressurised by the pressurised gas 422 in the headspace of the pressure vessel 420. The pressurised liquid electrolyte 50, 55 may be driven by its pressure to exit the pressure vessel 420 via external first pipe 42. In so doing, pressurised liquid electrolyte 50, 55 may flow into the flow channel 40 due to the pressure exerted by the liquid electrolyte 50, 55.
(5) The resulting pressure of the liquid electrolyte 50, 55 inside the flow channel 40 may drive the liquid electrolyte 50, 55 to flow out of the flow channel 40 via external second pipe 41.
(6) The pressure of the liquid electrolyte 50, 55 created by the pressurised gas 422, may cause the liquid electrolyte 50, 55 to flow through the flow channel 40, entering via external first pipe 42 and exiting via external second pipe 41.

FIG. 2, in part, further illustrates the additional or alternative case where the flow of liquid electrolyte 50, 55 into, out of, or through the flow channel 40 is driven by de-pressurising the liquid electrolyte 50, 55 in an external pipe, for example by connecting an ejector 410 to the external second pipe 41. In this case:
(7) An ejector, E, 410, is attached to external second pipe 41 on one side and may be provided with an external third pipe 41a on the other side. The ejector 410 may be placed in-line in an external pipe. When operated, the ejector 410 reduces the pressure of the liquid electrolyte 50, 55 in external second pipe 41. This may cause liquid electrolyte 50, 55 to flow out of flow channel 40 into external second pipe 41. Liquid electrolyte 50, 55 can then flow out of external third pipe 41a in the second direction 51b/56b.
(8) In so doing, fresh liquid electrolyte 50, 55 may also by drawn to flow into flow channel 40 from external first pipe 42.
(9) The liquid electrolyte 50, 55 may also be drawn through the flow channel 40 by entering from external first pipe 42 and exiting at external first pipe 41 under the impetus of the reduced pressure of the liquid electrolyte 50, 55 due to the ejector E, 410, attached to external second pipe 41.

Alternatively, and optionally, the flow of liquid electrolyte 50, 55 into, out of, or through the flow channel 40 may be driven by a pump connected to the external first pipe 42 or the external second pipe 41 in fluid communication with the flow channel 40, wherein the pump pressurises (on one side) and/or de-pressurises (on the other side), the liquid electrolyte 50, 55.

It is to be understood that, whereas FIG. 1 and FIG. 2 depict two external pipes, external first pipe 42 and external second pipe 41, connected to flow chamber 40, there may be only one external pipe, either external first pipe 42 or external second pipe 41, connected to flow chamber 40, or there may be more than two external pipes connected to flow chamber 40.

It is to be understood that, when a cell contains engineering structures, such as pipes, vessels, pressure vessels, pumps, ejectors, pressurised gases, and the like, as described above, whose only possible intention is to induce a liquid electrolyte to flow in to, out of, or through a liquid flow channel, then the cell is “configured” to flow liquid electrolyte through a liquid flow channel.

Accordingly, the statements provided in section la above, to the effect that a cell 10 is “configured” to flow a poorly conductive liquid electrolyte 55 through the liquid flow channel 40, mean that the cell 10 contains engineering structures of the types described above, whose only possible intention is to induce a poorly conductive liquid electrolyte 55 to flow in to, out of, or through a liquid flow channel 40.

### 1d. Further Features of General Example Cells

Referring again to FIG. 1: Preferably but not exclusively, the first electrode 20 is a gas diffusion electrode. Preferably but not exclusively, the cell 10 contains a first chamber 60, adjacent to first electrode 20, that contains, at least in part, a body of a first gas 601, associated with first electrode 20. For example, the first gas 601 may be a reactant of the electrochemical reaction that reacts at first electrode 20, or the first gas 601 may be a product of the electrochemical reaction that is formed at first electrode 20. Optionally, the first electrode 20 is a first gas diffusion electrode 20 and hinders the movement of liquid electrolyte 50, 55 through the first gas diffusion electrode 20 from the flow channel 40 into the first chamber 60. The first electrode 20 may be in direct contact with the body of the first gas 601 that is located on the opposite side of the first electrode 20 to the liquid flow channel 40. Optionally, a first gas diffusion layer 201 that halts liquid intrusion, is placed between the first gas diffusion electrode 20 and the first chamber 60. Preferably but not exclusively, the first gas 601 may enter, leave, or pass through first chamber 60 in the direction 603a or in the direction 603b via external first chamber pipe 602 connected to first chamber 60. It is to be understood that, whereas FIG. 1 depicts one external first chamber pipe 602 connected to first chamber 60, there may be two or more external first chamber pipes connected to first chamber 60. The liquid flow channel 40 is positioned between the first electrode 20 and the second electrode 30, and the liquid flow channel 40 is for supplying a liquid electrolyte 50, 55 to the first electrode 20 and the second electrode 30.

Optionally, the second electrode 30 is a gas diffusion electrode. Optionally, the cell 10 contains a second chamber 65, adjacent to second electrode 30, wherein the second chamber 65 contains, at least in part, a body of a second gas 651, associated with second electrode 30. For example, the second gas 651 may be a reactant of the electrochemical reaction that reacts at second electrode 30, or the second gas 651 may be a product of the electrochemical reaction that is formed at second electrode 30. Optionally, the second electrode 30 is a second gas diffusion electrode 30 and hinders the movement of liquid electrolyte 50, 55 through the second gas diffusion electrode 30 from the flow channel 40 into the second chamber 65. The second electrode 30 may be in direct contact with the body of the second gas 651 that is located on the opposite side of the second electrode 30 to the liquid flow channel 40. Optionally, a second gas diffusion layer 301 that halts liquid intrusion, is placed between the second gas diffusion electrode 30 and the second chamber 65. Preferably, the second gas 651 may enter, leave, or pass through second chamber 65 in the direction 653a or in the direction 653b via external second chamber pipe 652 connected to second chamber 65. It is to be understood that, whereas FIG. 1 depicts one external second chamber pipe 652 connected to second chamber 65, there may be two or more external second chamber pipes connected to second chamber 65.

Preferably, during operation of the cell 10, a potential difference is applied across the first electrode 20 and the second electrode 30. Preferably but not exclusively, the potential difference applied across the first electrode 20 and the second electrode 30 is more than +0.2 V or less than −0.2 V, more than +0.4 V or less than −0.4 V, more than +0.6 V or less than −0.6 V, more than +0.8 V or less than −0.8 V, more than +1.0 V or less than-1.0 V, more than +1.1 V or less than −1.1 V, more than +1.2 V or less than −1.2 V, more than +1.3 V or less than −1.3 V, more than +1.4 V or less than −1.4 V, more than +1.5 V or less than −1.5 V, more than +1.6 V or less than −1.6 V, more than +1.7 V or less than −1.7 V, more than +1.8 V or less than-1.8 V, more than +1.9 V or less than −1.9 V, more than +2.0 V or less than −2.0 V, more than +2.1 V or less than −2.1 V, more than +2.3 V or less than −2.3 V, more than +2.5 V or less than −2.5 V, more than +3.0 V or less than −3.0 V, or more than +5.0 V or less than −5.0 V.

In a preferred embodiment, there is provided a cell 10 of the type depicted in FIG. 1 and FIG. 2, wherein, during operation of the cell 10, when a potential difference is applied across the first electrode 20 and the second electrode 30, a poorly conductive liquid electrolyte 55 flows into, out of, or through the flow channel 40 between the first electrode 20 and the second electrode 30 in either a first direction 56a or a second direction 56b. Preferably but not exclusively, the flow of the poorly conductive liquid electrolyte 55 into, out of, or through the flow channel 40 is driven by gravity, and/or by pressurising or de-pressurising the liquid electrolyte 55 in the external first pipe 42 or the external second pipe 41 in fluid communication with the flow channel 40, as described in (1)-(9) above.

Preferably, despite the presence of a poorly conductive liquid electrolyte 55 in the flow channel 40 between the first electrode 20 and the second electrode 30, the electrochemical performance of cell 10 is consistent with a low impedance between the electrodes of less than or equal to 1.20 Ω cm², less than or equal to 1.00 Ω cm², less than or equal to 0.80 Ω cm², less than or equal to 0.60 Ω cm², less than or equal to 0.40 Ω cm², less than or equal to 0.35 Ω cm², less than or equal to 0.30 Ω cm², less than or equal to 0.25 Ω cm², less than or equal to 0.20 Ω cm², less than or equal to 0.15 Ω cm², less than or equal to 0.13 Ω cm², less than or equal to 0.11 Ω cm², less than or equal to 0.09 Ω cm², less than or equal to 0.07 Ω cm², less than or equal to 0.05 Ω cm², less than or equal to 0.04 Ω cm², less than or equal to 0.03 Ω cm², less than or equal to 0.02 Ω cm², or less than or equal to 0.01 Ω cm².

The following section 2 describes the inventors' discovery and application as to how an electro-synthetic or electro-energy cell with a poorly conductive liquid electrolyte 55 in the flow channel 40 between the first electrode 20 and the second electrode 30, may simultaneously have a low impedance, including but not limited to, during operation.

### 2. Capacitive Concentration of Ions at Electrodes and Its Utility

### 2a. Creating Capacitive Concentration of Ions at Electrodes (Cell Start-up)

FIG. 3 schematically depicts a portion of an example embodiment electro-synthetic or electro-energy cell 10 and method of operation. The cell 10 comprises of a first electrode 20 (e.g. a cathode), a second electrode 30 (e.g. an anode), and a flow channel 40 between the two electrodes.

In schematic I in FIG. 3, the flow channel 40 has been filled with a highly conductive liquid electrolyte 50 comprising a high concentration of ions A+and B-dissolved in a liquid solvent, for example water. The following components are cumulatively labelled cell components 71 in FIG. 3: the first electrode 20 and the second electrode 30, as well as the flow channel 40, which has the width 70, and is filled with a highly conductive liquid electrolyte 50.

The ions within the highly conductive liquid electrolyte 50 in the flow channel 40, may typically ion-pair with each other, meaning that each ion A⁺ will have a counter-ion B associated with it and near to it. In a non-limiting example, the ion A⁺ may be K⁺ and the ion B⁻ may be OH, dissolved in water, with a KOH concentration of ~0.2-12.0 M. In a second non-limiting example, the ion A⁺ may be Na⁺ and the ion B⁻ may be OH⁻, dissolved in water, with a NaOH concentration of ~0.2-12.0 M. In another non-limiting example, the ion A⁺ may be H⁺ and the ion B⁻ may be HSO₄⁻, dissolved in water, with a H₂SO₄ concentration of ~0.2-12.0 M. In further non-limiting examples, the ion A⁺ may be H⁺ and the ion B⁻ may be ClO₄⁻ or Cl⁻, dissolved in water, with a HClO₄ or HCl concentration, respectively, of ~0.2-12.0 M.

The inventors have discovered that, when the width 70 (i.e. the distance) between the first electrode 20 and the second electrode 30 is small and a potential difference or a current is applied at step 80 across the electrodes, causing the electrodes to become polarised, then some, or many, of the ions in a highly conductive liquid electrolyte 50 like those described above, located between the electrodes, may instead ion pair with the polarised electrodes and not with each other. That is, many ions may become capacitively concentrated at the electrodes, as shown in Schematic II. When a poorly conductive electrolyte 55 is located, or flowing, between the electrodes (Schematic III), the effective impedance of the cell may, however, be essentially unaffected because notable concentrations of ions remain available at the electrodes to migrate between the electrodes. Moreover, the distance of that migration is only small as the inter-electrode gap, being of width 70, is only small. Accordingly, the cell may retain its low impedance despite having a poorly conductive liquid electrolyte 55 between the electrodes. A poorly conductive liquid electrolyte 55 may then also be used in the cells and cell system (for example, by being circulated). If that poorly conductive liquid electrolyte 55 is also a low corrosion electrolyte, it may, thereby, provide for improvements in the corrosion of the cell and cell system over time, including amplified durability, performance, and other improvements.

This process is illustrated in schematics I-III in FIG. 3, which depicts the cell 10 wherein the width 70 of the liquid flow channel 40, i.e. the inter-electrode gap or distance, between the first electrode 20 and the second electrode 30 is small. In one non-limiting example, the width 70 of the liquid flow channel 40, i.e. the inter-electrode gap or distance, may be 0.20 mm or less. In Schematic I, a highly conductive liquid electrolyte 50 is present in the flow channel 40 between the electrodes 20 and 30. When the first electrode 20 and the second electrode 30 are polarised by having a potential (voltage) difference or current applied between the first electrode 20 and the second electrode 30, one electrode becomes negatively charged (for example, first electrode 20 in FIG. 3) and the other electrode become positively charged (for example, second electrode 30 in FIG. 3). This, in turn, causes the ions A⁺ and B⁻ to migrate to and ion-pair with the electrodes as depicted in schematic II in FIG. 3. The ions A⁺ migrate to and ion-pair with the negatively charged electrode (for example, first electrode 20 in FIG. 3), while the ions B⁻ migrate to and ion-pair with the positively charged electrode (for example, second electrode 30 in FIG. 3), thereby capacitively concentrating the ions at the electrodes, as shown in Schematic II. When the poorly conductive liquid 55 flows within the liquid flow channel 40 and becomes located between the electrodes 20 and 30, as shown in Schematic III, the cell may, nevertheless, operate with a low impedance because notable concentrations of ions remain available at the electrodes to migrate between the electrodes, thereby also promoting high catalytic activity at the electrodes. Moreover, the distance of the migration is the same as the inter-electrode gap, being of width 70, which is small.

For example, a highly conductive liquid electrolyte 50 that comprises a ~0.2-12.0 M aqueous solution of KOH, NaOH, H₂SO₄, HClO₄, or HCl, may initially be placed between the electrodes 20 and 30 (Schematic I in FIG. 3). Upon polarising the electrodes, some or many of the ions capacitively concentrate at the respective electrodes 20 and 30 as shown in Schematic II in FIG. 3. When a poorly conductive liquid 55 flows within the liquid flow channel 40, in one of the directions 56a or 56b, and is located between the electrodes 20 and 30 (Schematic III), the impedance of the cell 10, may be essentially unaffected because notable local concentrations of ions remain at the electrodes, from where the ions may readily migrate to the other electrode, thereby also promoting high catalytic activity at the electrodes. Moreover, the other electrode is very close, meaning that there is little resistance to ion migration between the electrodes, as is needed during the electrochemical reaction.

The cumulatively labelled cell components 71 in Schematic I of FIG. 3 then become cumulatively labelled cell components 72 in Schematic II: being the first electrode 20 and the second electrode 30, as well as the flow channel 40, which has the width 70, and is filled with a partially depleted conductive liquid electrolyte 50d.

It is to be understood that the ions in liquid electrolyte 50 need not have a charge of +1 or −1 (as in A⁺ and B⁻). They may, alternatively, have multiple charges, for example, +2 or −2, +3 or −3, +4 or −4, and so on. That is, the ions may be, for example, be cations such as M²⁺, M³⁺, and so forth, or anions such as X²⁻, X³⁻, and so forth. Moreover, the ion pairs in Schematic I in FIG. 3 may be mixtures of ions having different charges, for example, M²⁺(X⁻)₂, M³⁺(X⁻)₃, (M⁺)₂X²⁻, (M⁺)₃X³⁻, and the like. In all such cases, the ions may still be capacitively concentrated at the electrodes as depicted in schematic II in FIG. 3, when a potential difference or current is applied between the electrodes.

### 2b. A Cell in Normal Operation

The cell may then be operated as an electro-synthetic or electro-energy cell by passing, at step 82, the poorly conductive liquid electrolyte 55 into, out of, or through the flow chamber 40 between the electrodes, in either a first direction 56a or a second direction 56b, as depicted in schematic III in FIG. 3. During such operation, the cell will continue to have a low impedance provided only that the potential difference between the first electrode 20 and the second electrode 30 is always maintained during operation (since it is the applied voltage that capacitively concentrates the ions at the electrodes). The same poorly conductive liquid electrolyte 55 may be used in other parts of the electrolyser, for example in the cell system. If the poorly conductive liquid electrolyte 55 is also a low corrosion electrolyte, this may provide for decreased corrosion of the cell and cell system (relative to the use of a highly conductive, high corrosion liquid electrolyte, as is employed in many electro-synthetic or electro-energy cells and cell systems).

The potential difference applied to the first electrode 20 and the second electrode 30 in schematic II may be below the decomposition voltage of the liquid electrolyte itself. For example, a potential difference of 1.2 V, which is below the decomposition voltage of water, may be applied to an aqueous 6 M KOH electrolyte within an alkaline electrolyser cell. In cells in which decomposition of the liquid forms part of the electrochemical process, the potential difference may exceed the decomposition voltage.

Accordingly, electro-synthetic or electro-energy cell cells in which ions have been capacitively concentrated at the electrodes, as shown in schematic III in FIG. 3 may operate with low impedance even when an electrolyte having a low concentration of ions—a poorly conductive liquid electrolyte-is passed between the electrodes. If the poorly conductive liquid electrolyte is also a low corrosion electrolyte, the pipes, valves, tanks, sensors, manifolds, headers, pumps and other plumbing features and engineering equipment that are in fluid communication with the cell may experience reduced corrosion leading to increased durability, lifetime, performance and other benefits. Additionally, or alternatively, lower cost materials that are less corrosion resistant may be used in the cell itself and its cell system.

### 2c. Cell Failure (catastrophic)

As noted above, a critical qualifier of such a cell is that the potential difference across the first electrode 20 and the second electrode 30 shown in schematics II and III in FIG. 3, must be always maintained during operation of the cell. If that potential difference is reduced, zeroed, or reversed in bias at any time during operation, even momentarily, then the electrodes may capacitively discharge, causing the ions to be released partially or fully from the electrodes. The released ions may subsequently disperse into the full extent of the poorly conductive liquid electrolyte 55, including in the cell system, thereby destroying the low impedance of the cell.

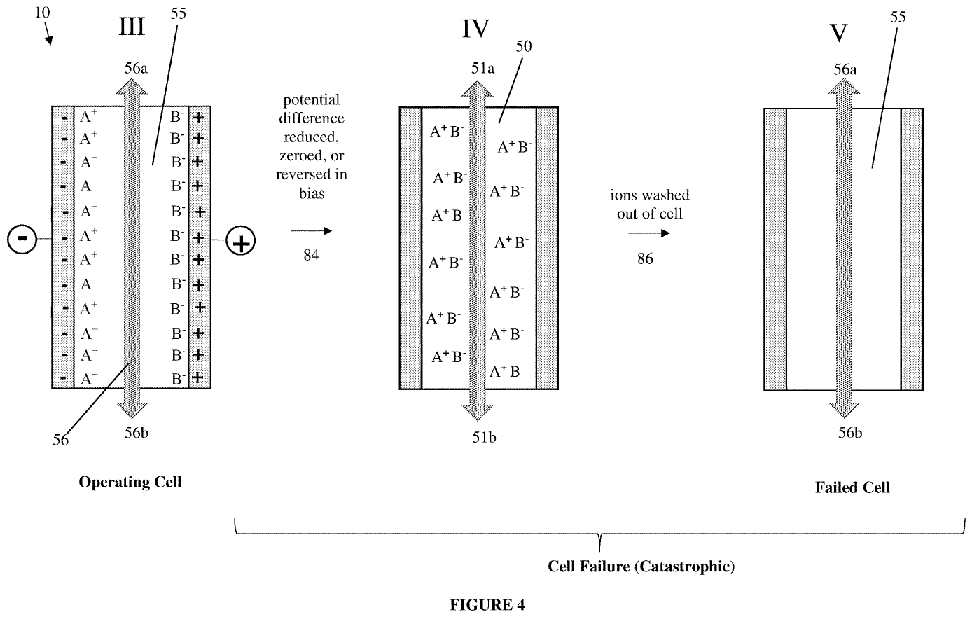

FIG. 4 schematically depicts what the inventors have found may happen in such a case. Schematic III in FIG. 4 shows the cell under normal operating conditions, wherein the ions are capacitively concentrated at the electrodes by an applied voltage, with a poorly conductive liquid electrolyte 55 passing into, out of, or through the cell 10 in the direction 56a or direction 56b. If the potential difference between the electrodes is reduced, zeroed, or reversed in bias, at step 84, at any time during operation of the cell, even momentarily, then the ions may be released from the first electrode 20 and the second electrode 30, as shown in schematic IV in FIG. 4. The flow of poorly conductive liquid electrolyte (which contains essentially no ions) into, out of, or through the cell may then cause the ions in the highly conductive liquid electrolyte 50 to be removed from the cell, at step 86, leaving only the poorly conductive liquid electrolyte 55 in the cell as shown in schematic V in FIG. 4. As there are then only very few or no ions A⁺ and B⁻ in the cell, to mediate the electrochemical reaction between the first electrode 20 and the second electrode 30, the impedance of the cell may increase drastically. That is, the electrochemical reaction in the cell may fail completely and catastrophically. The cell may no longer be capable to carrying out the electrochemical reaction.

### 2d. Cell Regeneration

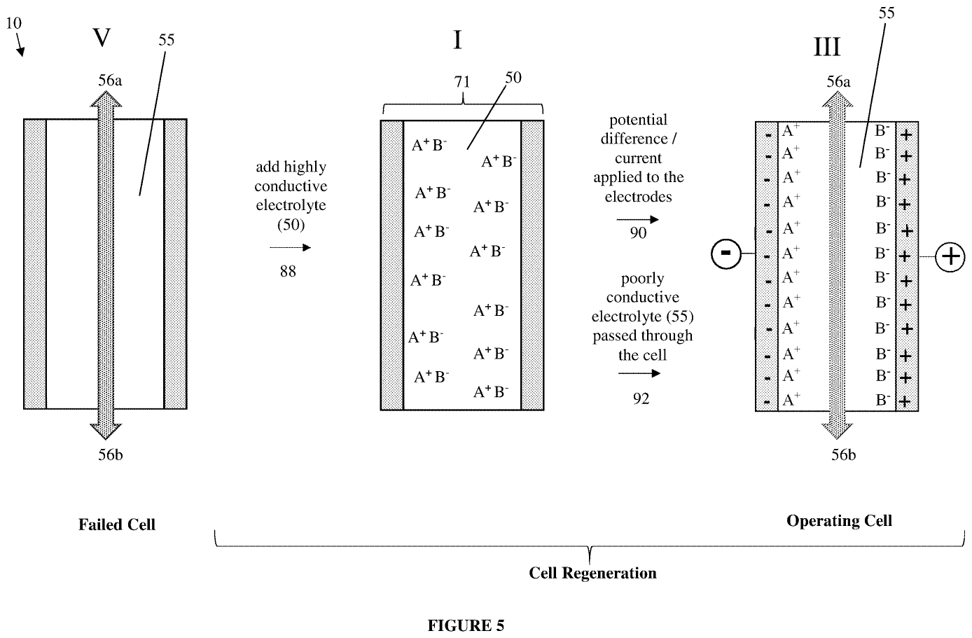

A failed cell that has lost its low impedance, of the type shown in schematic V in FIG. 4, may be fully re-habilitated and restored to its normal operating state by following the procedure depicted schematically in FIG. 5. Schematic V on the left of FIG. 5 depicts the catastrophically failed cell. At step 88, a volume of highly conductive liquid electrolyte 50, containing a high concentration of ions A⁺ and B⁻, may be passed into the flow channel 40 between the first electrode 20 and the second electrode 30 in the cell. This may re-establish the state of cell components 71 depicted in schematic I of FIG. 3. If a potential difference is applied across the electrodes when the cell components are in state 71, at step 90, the state of cell components 72 depicted in schematic II in FIG. 3 may be re-established. Poorly conductive liquid electrolyte 55 may then be passed into, out of, or through the cell, at step 92, re-establishing normal operation as shown in schematic III in FIG. 3.

### 2e. Cell Degradation

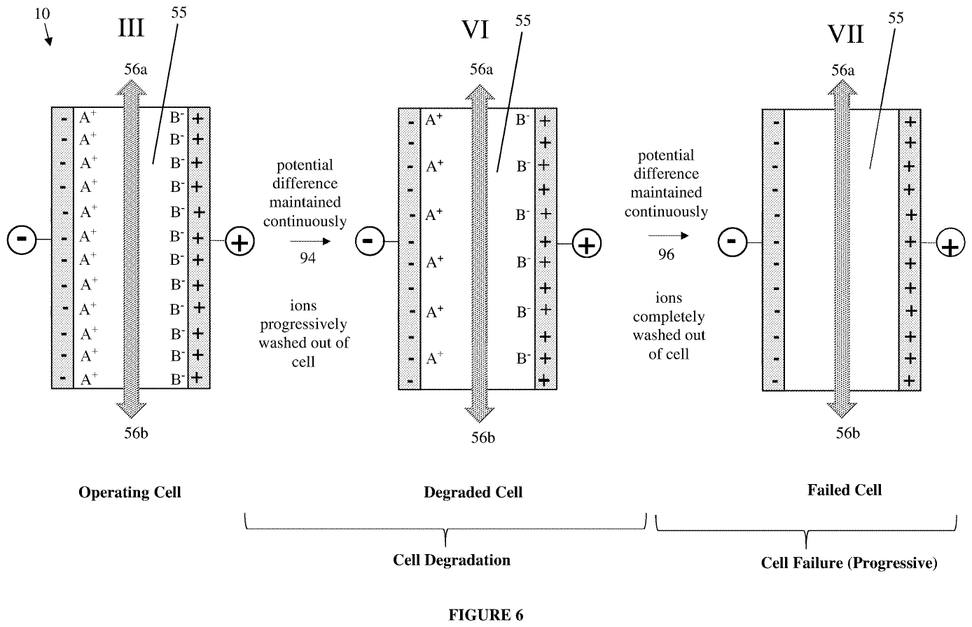

The electrochemical performance of a normal, operating cell of the type depicted in schematic III in FIG. 3 may also degrade slowly over time due to a degradation in the impedance of the cell between the electrodes. FIG. 6 depicts the mode of degradation in the impedance. On the left of FIG. 6 is an operating cell (Schematic III). Despite continuously maintaining the potential difference between the electrodes, ions may slowly but progressively be washed out of the cell over time, at step 94, as shown in schematic VI. The resulting reduction in the concentration of capacitively held ions at the electrodes may, in turn, slowly but progressively increase the impedance of the cell. The cell may therefore, over time, demonstrate a declining electrochemical performance. This decline may continue, at step 96, until there are essentially no ions in the cell, as depicted in schematic VII in FIG. 6. Such a state also amounts to a failed cell, except that the cell failure will have occurred by progressive degradation rather than by sudden, catastrophic failure.

Both a cell that has partially degraded (e.g. schematic VI in FIG. 6) as well as a cell that has progressively degraded to the point of cell failure (e.g. schematic VII in FIG. 6) may be rehabilitated using the cell regeneration process described above and depicted in FIG. 5.

The inventors have found that the rate of degradation (schematic III→VI in FIG. 6) is strongly influenced by the strength of the electric field created between the electrodes by the applied potential difference between the electrodes. Thus, the smaller the inter-electrode distance (width 70 in FIG. 1) and the greater the voltage difference that is applied to the electrodes (in either the positive or negative direction), the greater is the electric field and the more strongly the ions A⁺ and B⁻ are capacitively held at the electrodes. Strongly held ions are washed out of the cell more slowly than weakly held ions, leading to slower degradation of the electrochemical performance of the cell.

The inventors have also found that the degradation described in FIG. 6 (schematic III→VI) may be counteracted, slowed, and even indefinitely halted, by including (or introducing) a suitably low but fixed concentration of ions A⁺ and B⁻ in the poorly conductive liquid electrolyte 55 that is passed into, out of, or through the cell. The additional ions present in the poorly conductive liquid electrolyte 55 may replace the ions that are lost during the degradation, by capacitively ion pairing with the polarised first electrode 20 and second electrode 30.

For example, studies by the inventors have revealed that, within an alkaline water electrolysis cell with an inter-electrode gap or distance (i.e. width 70) of ≤0.20 mm and an initial liquid electrolyte 50 of 6 M KOH (schematic I in FIG. 3), with a voltage of ≥1.2 V applied across the electrodes (schematic II in FIG. 3), operating at room temperature, the degradation may be essentially indefinitely halted by including (or introducing) an aqueous solution of 0.1 M KOH in the poorly conductive liquid electrolyte 55 (schematic III in FIG. 3). However, cells with larger inter-electrode distances degrade more rapidly under the same conditions. For example, a cell with an inter-electrode gap or distance (i.e. width 70) of 0.40 mm was found to commence degradation within several hours, while cells with inter-electrode distances of 0.70 mm or 1 mm were found to degrade very rapidly, including to cell failure, within a mere one hour. Accordingly, a small inter-electrode gap or distance (i.e. width 70) is a critical feature of preferred embodiment cells.

### 3. Engineering of Preferred Embodiments

Referring to FIG. 1: The width 70 of the flow channel 40 in a preferred embodiment electro-synthetic or electro-energy cell may, preferably but not exclusively, be maintained by sandwiching the first electrode 20 and the second electrode 30 against opposite sides of a porous spacer that may be imbued with liquid electrolyte. Preferably, the porous spacer is substantially flat, electrically insulating, i.e. a non-conductive porous spacer, and allows liquid to freely pass through the porous spacer without hindrance, i.e. is a liquid-permeable porous spacer. For example, the porous spacer may be a polymer net or a polymer mesh. Preferably but not exclusively, the porous spacer has a thickness of 0.20 mm or less. Examples of such polymer nets/meshes include, but are not limited to polymer nets/meshes produced or marketed by various companies, including, for example, Saint Goban and Claf (Eneos).

The inventors have found that, when a porous spacer, that may be imbued with liquid electrolyte, is incorporated into the flow channel 40, the longevity of a normal, operating cell of the type depicted in schematic III in FIG. 3 and the extent of the low impedance created by it, is strongly influenced by the porosity of the porous spacer. That is, the performance and durability of a normal operating cell like that depicted in schematic III in FIG. 3, is improved by having a high porosity in the porous spacer, for example, a porosity of more than 60%. The term ‘porosity’ refers to the proportion of the volume of a porous spacer that is void volume; i.e. that is empty space into which liquid electrolyte may flow. A porosity of more than 60% equates to a void volume of more than 60% in a porous spacer. This effect appears to be due to the number of ions present and available for capacitive concentration at the electrodes. Low void volumes, i.e. low porosities, in a porous spacer sandwiched between the electrodes within the flow channel 40, reduce the volume of liquid electrolyte between the electrodes, and thereby reduce the number of ions available to ion-pair with the electrodes. The lower the number of ions that are held at the electrodes, the faster they may be progressively lost (as shown in schematic VI in FIG. 6) before a cell experiences progressive cell failure (of the type depicted in schematic VII in FIG. 6). A porous spacer with a void volume of more than 60% is herein termed a ‘highly porous spacer’. Preferably but not exclusively, the porous spacer is therefore a ‘highly porous spacer’ that may be imbued with liquid electrolyte and has a porosity (i.e. a void volume) of more than 60%, more than 62%, more than 64%, more than 66%, more than 68%, more than 70%, more than 72%, more than 74%, more than 76%, more than 78%, more than 80%, more than 82%, more than 84%, more than 86%, more than 88%, or more than 90%.

The inventors have further found that the extent to which the electrodes are compressed against a porous spacer sandwiched between them, may also influence the performance and durability of a normal operating cell like that depicted in schematic III in FIG. 3. The higher the clamping force with which the electrodes are compressed against the opposite sides of the porous spacer, the better the impedance and the longevity of the cell during normal operation. This is believed to be due to a minimisation of the width 70 between the electrodes at all points along the length of the flow channel 40, with accompanying improvements in the electric field applied, the number of ions capacitively held at the electrodes, the strength with which they are held, and other factors. Higher clamping forces may also provide better physical contact between the electrodes and the liquid electrolyte within a porous spacer sandwiched between them.

Preferably but not exclusively, the first electrode 20 and the second electrode 30 are compressed against the porous spacer with a clamping force of 2 bar or more to thereby ensure that the electrodes are in close and tight contact with the porous spacer at all locations. In preferred examples, the first electrode 20 and the second electrode 30 are compressed against the porous spacer with a clamping force of 2 bar or more, 3 bar or more, 5 bar or more, 7 bar or more, 9 bar or more, 10 bar or more, 12 bar or more, 14 bar or more, 15 bar or more, 20 bar or more, 25 bar or more, 30 bar or more, 35 bar or more, or 50 bar or more.

Preferably, polymer nets or polymer meshes of the type referred to above are fabricated using polymers that are resistant to corrosion by the liquid electrolyte 50 and the liquid electrolyte 55. Examples of such polymer nets are produced or marketed by various companies, including Saint Goban and Claf (Eneos). For example, the latter company markets polyolefin nets of thickness 0.090-0.198 for food packaging applications. Polyolefins are generally resistant to corrosion by strongly alkaline liquid electrolytes, such as 6 M KOH.

A variety of polymers and other materials may be used in such an electrically insulating, porous spacer, including but are not limited to various types, or combinations of types, or hybrids of different types, including, without limitation: PVDF, PTFE, tetrafluoroethylene, fluorinated polymers of various types; polyimides, polyamides, nylon, nitrogen-containing materials of various types; glass fibre, silicon-containing materials of various types; polyvinyl chloride, chloride-containing polymers of various types, cellulose acetate, cellulose nitrate, cellophane, ethyl-cellulose, cellulose-containing materials of various types; polycarbonate, carbonate-containing materials of various types; polyethersulfone, polysulfone, polyphenylsulfone, sulfone-containing materials of various types; polyphenylene sulphide, sulphide-containing materials of various types; polypropylene, polyethylene, polyolefins, olefin-containing materials of various types; asbestos, titanium-based ceramics, zirconium-based ceramics, ceramic materials of various types; polyvinyl chloride, vinyl-based materials of various types; rubbers of various types; porous battery separators of various types; and clays of various types.

### 4. Preferred Embodiments Containing at Least One Porous Capillary Spacer

In other example embodiments, a specific type of porous spacer, known as a ‘porous capillary spacer’ that may be imbued with liquid electrolyte may be used in preferred embodiment electro-synthetic or electro-energy cells.

The flow channel 40 may be completely or partially filled by the ‘porous capillary spacer’, as defined in International Patent Publication Nos. WO2022056603, WO2022056604, WO2022056605, and WO2022056606, which are hereby incorporated by reference. A porous capillary spacer is a planar, porous structure (e.g. a flat-sheet membrane) that confines a liquid within it by a capillary effect. The liquid may be simultaneously induced to move through the porous structure by the capillary effect, or by other effects, including but not limited to diffusion or osmosis. In the case where the flow channel 40 is completely filled by a single porous capillary spacer that may be imbued with liquid electrolyte, preferably but not exclusively, the porous capillary spacer has a width of 0.20 mm or less. Preferably but not exclusively, the first electrode 20 and the second electrode 30 are compressed against the porous capillary spacer with a clamping force of 2 bar or more to thereby ensure that the electrodes are in close and tight contact with the porous capillary spacer at all locations and also to ensure that the first electrode 20 and the second electrode 30 are suitably wetted by the liquid electrolyte in the porous capillary spacer. In preferred examples, the first electrode 20 and the second electrode 30 are compressed against the porous capillary spacer with a clamping force of 2 bar or more, 3 bar or more, 5 bar or more, 7 bar or more, 9 bar or more, 10 bar or more, 12 bar or more, 14 bar or more, 15 bar or more, 20 bar or more, 25 bar or more, 30 bar or more, 35 bar or more, or 50 bar or more.

In the case where the flow channel 40 is completely occupied by a porous capillary spacer, that may be imbued with liquid electrolyte, liquid within the flow channel 40 or liquid passing into, out of, or through the flow channel 40 may be constrained by the capillary forces of the porous capillary spacer to largely remain in the flow channel 40. That is, there may then be no need for the first electrode 20 and/or the second electrode 30 to hinder the passage of liquid out of the flow channel 40 into the first chamber 60 and the second chamber 65 since the liquid in the flow channel 40 will be largely held in the flow channel 40 by the capillary forces of the porous capillary spacer. There may, moreover, be no need for the presence of first gas diffusion layer 201 and/or second gas diffusion layer 301, as shown in FIG. 1, which may otherwise have been required to halt the movement of liquid out of the flow channel 40 into first chamber 60 and/or second chamber 65, since the liquid in the flow channel 40 will be largely held in the flow channel 40 by the capillary forces of the porous capillary spacer.

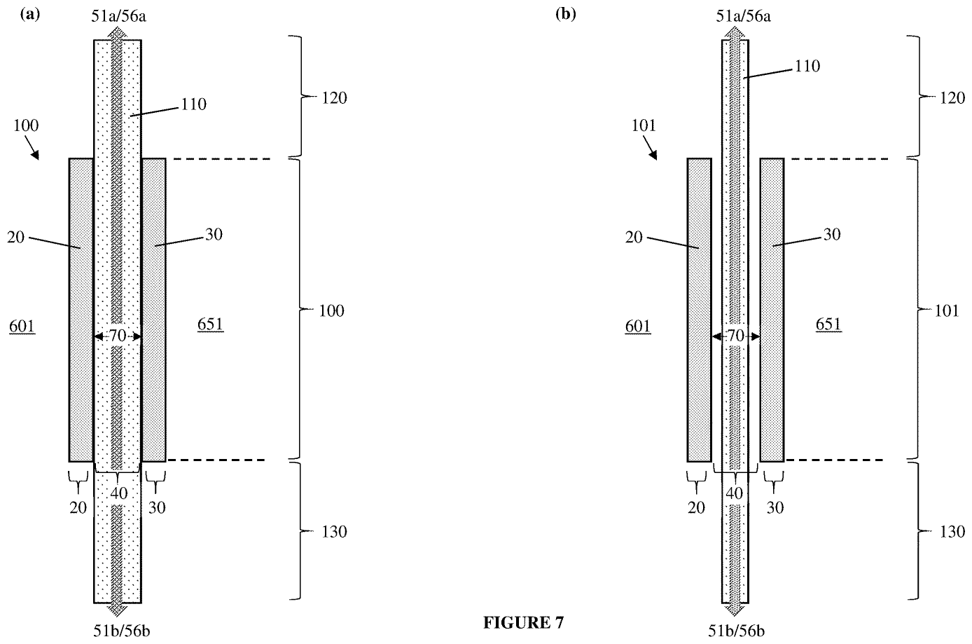

This example is depicted schematically, in cross-section, in FIG. 7(a), which shows a portion of an electro-synthetic or electro-energy cell 100, comprising a first electrode 20 and a second electrode 30, as well as a first gas 601 and a second gas 651 associated with the first and second electrodes respectively. A porous capillary spacer 110, that may be imbued with liquid electrolyte, completely fills the flow channel 40 having width 70. Liquid electrolyte 50 or 55 may flow into, out of, or through the flow channel 40 by flowing within the porous capillary spacer 110 in the direction 51a/56a and/or 51b/56b. The capillary forces that constrain and hold the liquid electrolyte 50 or 55 within the porous capillary spacer 110 may eliminate the need for the first electrode 20 and/or second electrode 30 to hinder the passage of liquid out of the flow channel 40 into the first chamber 60 and second chamber 65 (as shown in FIG. 1, but not shown for clarity in FIG. 7(a)) since the liquid in the flow channel 40 will be largely held in the flow channel 40 by the capillary forces of the porous capillary spacer 110. There may, moreover, be no need for first gas diffusion layer 201 and/or second gas diffusion layer 301 as shown in FIG. 1, which may, otherwise, have been required to halt the movement of liquid out of the flow channel 40 into first chamber 60 and/or second chamber 65.

FIG. 7(b) schematically depicts, in cross-section, a portion of an example electro-synthetic or electro-energy cell 101, wherein a porous capillary spacer 110, that may be imbued with liquid electrolyte, only partially fills the flow channel 40, which has a width 70. The cell 101, comprises a first electrode 20 and a second electrode 30, as well as a first gas 601 and a second gas 651 associated with the first and second electrodes respectively. Liquid electrolyte 50 or 55 may flow into, out of, or through the flow channel 40 by flowing within the porous capillary spacer 110 in the direction 51a/56a and/or direction 51b/56b. Liquid electrolyte 50 or 55 may separately flow into, out of, or through the flow channel 40 by flowing into, out of, or through those portions of the flow channel 40 that are not filled with porous capillary spacer 110, in the direction 51a/56a and/or direction 51b/56b. In such a case, the first electrode 20 and/or second electrode 30 may need to be gas diffusion electrodes that hinder the passage of liquid out of the flow channel 40 into the first chamber 60 and second chamber 65 (as shown in FIG. 1, but not shown for clarity in FIG. 7(b)) since not all of the liquid in the flow channel 40 will be subject to and constrained to remain in the flow channel 40 by the capillary forces of the porous capillary spacer 110. Additionally, or alternatively there may be a need for first gas diffusion layer 201 and/or second gas diffusion layer 301 (as shown in FIG. 1, but not shown for clarity in FIG. 7(b)) to halt the movement of liquid out of the flow channel 40 into first chamber 60 and/or second chamber 65 (as shown in FIG. 1, but not shown for clarity in FIG. 7(b)).

In still further examples, the porous capillary spacer, that may be imbued with liquid electrolyte, in the flow channel 40, may extend outside of, and beyond the flow channel 40. That is, the porous capillary spacer 110 in FIG. 7(a) or FIG. 7(b) may extend beyond the outer dimensions of the electrodes 20 and/or 30. In such cases, liquid electrolyte may flow into, out of, or through the flow channel 40, by flowing within first portion 120 or second portion 130 of the porous capillary spacer 110 located outside of the flow channel 40. Such liquid electrolyte flowing within first portion 120 or second portion 130 of the porous capillary spacer 110 located outside of the flow channel 40, may be constrained or held by the capillary forces of the porous capillary spacer 110 within first portion 120 or second portion 130 of the porous capillary spacer 110 located outside of the flow channel 40. That is, the first portion 120 or the second portion 130 of the capillary spacer 110 located outside of the flow channel 40, and beyond the extent or dimensions of the first electrode 20 and the second electrode 30, may, effectively, provide ‘capillary pipelines’ through which liquid may flow into, out of, or through the flow channel 40. Such ‘capillary pipelines’, i.e. first portion 120 or second portion 130, may constitute the equivalent of the external first pipe 42 and/or the external second pipe 41, as shown in FIG. 1.

As described in the discussion associated with FIG. 1, it is to be understood that liquid may flow into, out of, or through the flow channel 40 via one or more ‘capillary pipelines’ (e.g. first portion 120 or second portion 130, in FIG. 7(a)-(b)) located outside of the flow channel 40. For example, there may be one, two, three or more porous capillary spacers located outside of the flow channel 40, along which liquid flows into, out of, or through the flow channel 40. In some examples, such ‘capillary pipelines’ may be part of and contiguous with a porous capillary spacer 110, that may be imbued with liquid electrolyte, located within the flow channel 40; for example, first portion 120 or second portion 130 in FIG. 7(a)-(b) are contiguous with and part of the porous capillary spacer 110 that also passes through the flow channel 40 in the cell 100 or cell 101. In other examples, such ‘capillary pipelines’ may be separate to, and non-contiguous with porous capillary spacers present within the flow channel 40. In still further examples, there may be no porous capillary spacers within the flow channel 40 whatsoever, wherein liquid flowing into, out of, or through the flow channel 40, does so along ‘capillary pipelines’ that are located outside of the flow channel 40 but are in fluid communication with the flow channel 40.

In yet other examples, the flow channel 40 may be completely or partially filled by two or more porous capillary spacers that may be imbued with liquid electrolyte. The two or more porous capillary spacers in the flow channel 40, between the first electrode 20 and the second electrode 30, may touch, abut, border on, adjoin, neighbour, or be adjacent to each other.

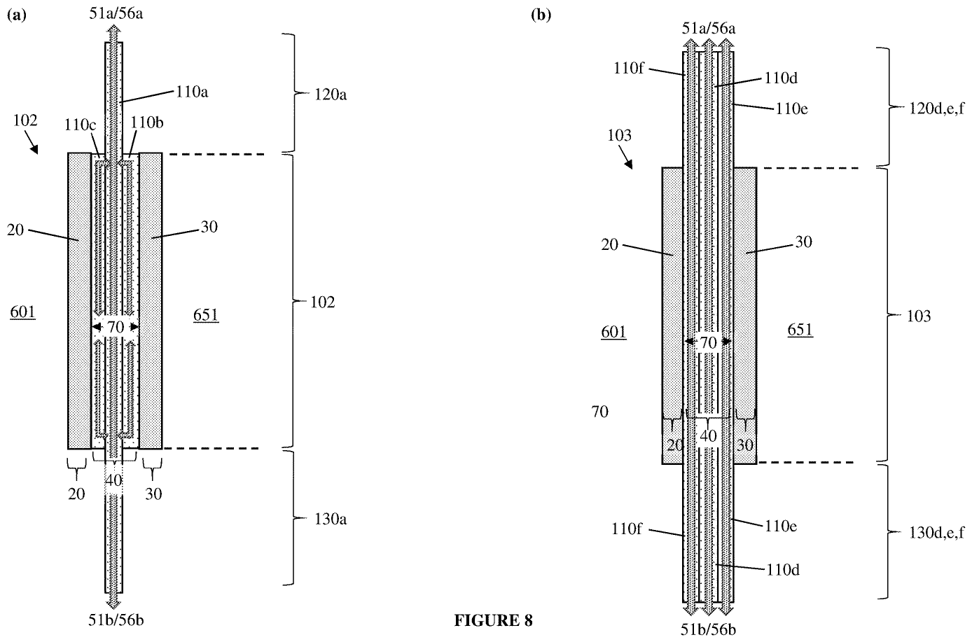

FIG. 8(a) schematically depicts in cross-section, portions of an example electro-synthetic or electro-energy cell 102, in which the flow channel 40 is completely filled by three porous capillary spacers that may each be imbued with liquid electrolyte, being a first porous capillary spacer 110a, a second porous capillary spacer 110b, and a third porous capillary spacer 110c. The cell 102, comprises a first electrode 20 and a second electrode 30, as well as a first gas 601 and a second gas 651 associated with the first and second electrodes respectively. Between the first electrode 20 and the second electrode 30, the porous capillary spacers 110a and 110b touch, abut, border on, adjoin, neighbour, or are adjacent to each other. Between the first electrode 20 and the second electrode 30, the porous capillary spacers 110a and 110c touch, abut, border on, adjoin, neighbour, and are adjacent to each other. Liquid electrolyte 50 or 55 may flow into, out of, or through the flow channel 40 by flowing within the porous capillary spacers 110a, 110b, and 110c in the direction 51a/56a and/or direction 51b/56b in FIG. 8(a).

In other examples, not depicted here, the flow channel 40 may be completely or partially filled by more than one porous capillary spacer that may be imbued with liquid electrolyte, wherein one or more of the capillary spacers in the flow channel 40 is separate from another, or the other capillary spacer(s) and does not touch, abut, border on, adjoin, neighbour, or be adjacent to another or the other porous capillary spacer/s.

In still further examples, at least one porous capillary spacer, that may be imbued with liquid electrolyte, in the example illustrated being the first porous capillary spacer 110a, present in the flow channel 40, may extend outside of, and beyond the flow channel 40. That is, at least one porous capillary spacer may extend beyond the outer dimensions of the first electrode 20 and/or the second electrode 30. In such cases, liquid may flow into, out of, or through the flow channel 40, by flowing within the first portion 120a or the second portion 130a of the at least one porous capillary spacer, in this example the first porous capillary spacer 110a, located outside of the flow channel 40. Such liquid flowing within the first portion 120a or the second portion 130a of first porous capillary spacer 110a outside of the flow channel 40, may be constrained and held within first porous capillary spacer 110a by the capillary forces of the first porous capillary spacer 110a. That is, the first portion 120a or the second portion 130a of the first porous capillary spacer 110a located outside of the flow channel 40 may, effectively, provide ‘capillary pipelines’ through which liquid may flow into, out of, or through the flow channel 40. Such ‘capillary pipelines’, provided by first portion 120a or second portion 130a, may constitute the equivalent of the external first pipe 42 and/or the external second pipe 41, as shown in FIG. 1. In the non-limiting example illustrated, there are three porous capillary spacers 110a, b, c and the middle or central porous capillary spacer extends outside of and beyond the flow channel 40, or extends beyond the outer dimensions of the first electrode 20 and/or the second electrode 30.

As described in the text associated with FIG. 1, it is to be understood that liquid may flow into, out of, or through the flow channel 40 via one or more ‘capillary pipelines’ located outside of the flow channel 40. For example, there may be one, two, three or more porous capillary spacers, that may each be imbued with liquid electrolyte, located outside of the flow channel 40, along which liquid flows into, out of, or through the flow channel 40. In some examples, such ‘capillary pipelines’ may be part of and contiguous with porous capillary spacers located within the flow channel 40. In other examples, such ‘capillary pipelines’ may be separate to, and non-contiguous with porous capillary spacers within the flow channel 40. In still further examples, there may be no porous capillary spacers within the flow channel 40, wherein liquid flowing into, out of, or through the flow channel 40, does so along ‘capillary pipelines’ that are in fluid communication with the flow channel 40.

FIG. 8(b) schematically depicts in cross-section, portions of an example electro-synthetic or electro-energy cell 103, in which the flow channel 40 is filled by three porous capillary spacers, that may each be imbued with liquid electrolyte, being a first porous capillary spacer 110d, a second porous capillary spacer 110e, and a third porous capillary spacer 110f. The cell 103, comprises a first electrode 20 and a second electrode 30, as well as a first gas 601 and a second gas 651 associated with the first and second electrodes respectively. Between the first electrode 20 and the second electrode 30, the porous capillary spacers 110d and 110e touch, abut, border on, adjoin, neighbour, or are adjacent to each other. Between the first electrode 20 and the second electrode 30, the porous capillary spacers 110d and 110f touch, abut, border on, adjoin, neighbour, and are adjacent to each other. Liquid electrolyte 50 or 55 may flow into, out of, or through the flow channel 40 by flowing within the porous capillary spacers 110d, 110e, and 110f in the direction 51a/56a and/or direction 51b/56b in FIG. 8(b). The portions of the porous capillary spacers 110d, 110e, and 110f that lie outside of the flow channel 40, namely first portions 120d,e,f and second portions 130d,e,f, constitute ‘capillary pipelines’ along which liquid electrolyte 50 or 55 may flow into, out of, or through the flow channel 40. In the non-limiting example illustrated, there are three porous capillary spacers 110d,e,f and each porous capillary spacer extends outside of and beyond the flow channel 40, or extends beyond the outer dimensions of the first electrode 20 and/or the second electrode 30.

In other examples, there may be a porous capillary spacer, that may be imbued with liquid electrolyte, within the flow channel 40 that is in fluid communication with more than one porous capillary spacer located outside of the flow channel 40, where such porous capillary spacer acts as a ‘capillary pipeline’ along which liquid may flow into, out of, or through the flow channel 40.

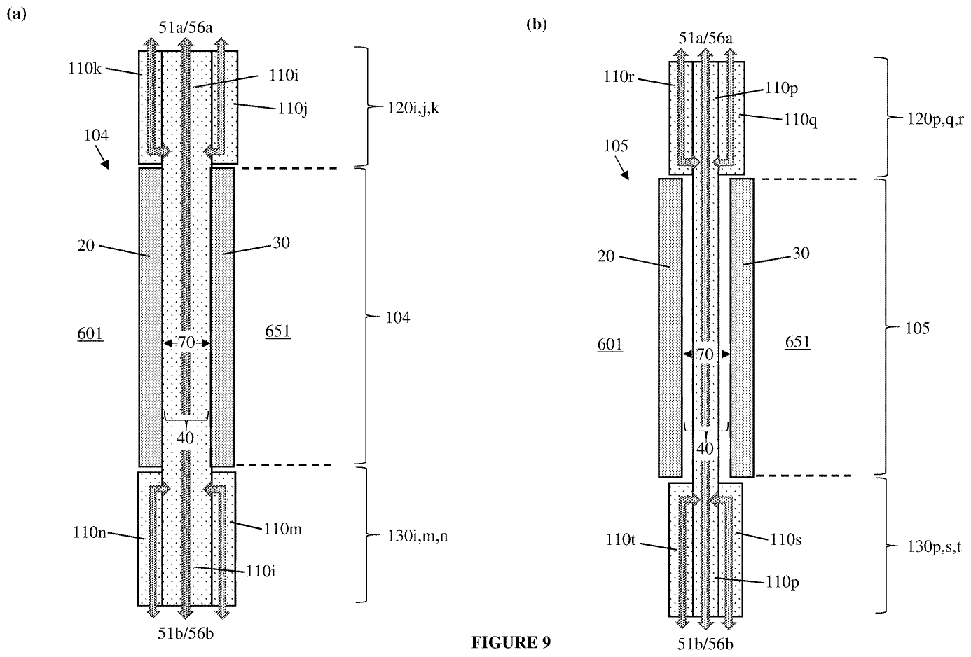

FIG. 9(a) schematically depicts in cross-section, portions of an example electro-synthetic or electro-energy cell 104, in which the flow channel 40 is filled by a single porous capillary spacer 110i, that may be imbued with liquid electrolyte. The cell 104, comprises a first electrode 20 and a second electrode 30, as well as a first gas 601 and a second gas 651 associated with the first and second electrodes respectively. Liquid electrolyte 50 or 55 may flow into, out of, or through the flow channel 40 by flowing along and within the porous capillary spacers 110i, 110j, 110k, 110m, and/or 110n, that may each be imbued with liquid electrolyte, in the direction 51a/56a and/or direction 51b/56b, as shown in FIG. 9(a). The portions of the porous capillary spacers 110i, 110j, 110k, 110m, and/or 110n, that may each be imbued with liquid electrolyte, that lie outside of the flow channel 40, namely first portions 120i,j,k and second portions 120i,m,n, constitute ‘capillary pipelines’ along which liquid electrolyte 50 or 55 may flow into, out of, or through the flow channel 40. Porous capillary spacers 110j, 110k, 110m, 110n can be physically distinct or separate porous capillary spacers in fluid communication with porous capillary spacer 110i.

FIG. 9(b) schematically depicts in cross-section, portions of an example electro-synthetic or electro-energy cell 105, in which the flow channel 40 is only partially filled by a single porous capillary spacer 110p, that may be imbued with liquid electrolyte. The cell 105, comprises a first electrode 20 and a second electrode 30, as well as a first gas 601 and a second gas 651 associated with the first and second electrodes respectively. Liquid electrolyte 50 or 55 may flow into, out of, or through the flow channel 40 by flowing along and within the porous capillary spacers 110p, 110q, 110r, 110s, and/or 110 t, that may each be imbued with liquid electrolyte, in the direction 51a/56a and/or direction 51b/56b, as shown in FIG. 9(b). The portions of the porous capillary spacers 110p, 110q, 110r, 110s, and/or 110t that lie outside of the flow channel 40, namely first portions 120p,q,r and second portions 120p,s,t, constitute ‘capillary pipelines’ along which liquid electrolyte 50 or 55 may flow into, out of, or through the flow channel 40. Porous capillary spacers 110q, 110r, 110s, 110t can be physically distinct or separate porous capillary spacers in fluid communication with porous capillary spacer 110p.

While in all cases described above, liquid electrolyte 50 or 55 may flow into, out of, or through the flow channel 40 thanks to a capillary action created by a porous capillary spacer, that may be imbued with liquid electrolyte, it is to be understood that such flow may also be influenced by other external factors. For example, liquid electrolyte 50 or 55 may, nevertheless, still be induced to flow into, out of, or through the flow channel 40 under the additional impetus of gravity, and/or by pressurising or de-pressurising the liquid electrolyte 50 or 55 in an external first pipe 42 or external second pipe 41, as described earlier. The flow created in such cases may oppose the direction of flow induced by the capillary action created by the at least one porous capillary spacer.

It is to be further understood that many structural combinations and permutations of porous capillary spacers and ‘capillary pipelines’ may be made within example embodiment cells. It is not possible to depict and describe here all such permutations and combinations. Nevertheless, all such permutations and combinations, without limitation, fall within the scope of the present invention.

### 5. Further Methods of Operation

In a further example aspect, there is provided a method of operating an electro-synthetic or electro-energy cell, the method comprising:
(1) Filling a flow channel 40 of width 0.20 mm or less, between two electrodes, being a first electrode 20 and a second electrode 30, within an electro-synthetic or electro-energy cell, with a highly conductive liquid electrolyte;
(2) Applying and thereafter maintaining a potential difference at the two electrodes, being a first electrode 20 and a second electrode 30, (to thereby capacitively concentrate the ions in the highly conductive liquid electrolyte at the polarised electrodes);
(3) Flowing a poorly conductive liquid electrolyte into, out of, or through the flow channel;
(4) Operating the cell as an electro-synthetic or electro-energy cell with an impedance of 1.2 Ω cm² or less.

There is further provided a method of re-generating a failed or degraded cell of the above type, the method comprising repeating the steps (1) to (4) above.

There is also provided a method of slowing the degradation of a cell of the above type, wherein that degradation occurs due to a progressive loss of capacitively held ions at the electrodes. The method comprises adding replenishment ions to the poorly conductive liquid electrolyte that flows into, out of, or through the cell. For example, instead of using de-ionized water as the poorly conductive liquid electrolyte, 0.1 M KOH may be used, wherein the additional K⁺ and OH⁻ ions replace K⁺ and OH⁻ ions that are lost during cell degradation.

### 6. Electrolytes

While the examples above employed strong acids or bases in the liquid electrolyte 50 and 55, wherein liquid electrolyte 50 comprised of high concentrations of the strong acids or bases and liquid electrolyte 55 comprised of low concentrations of the strong acids and bases, it is to be understood that a wide range of other liquids may be employed as liquid electrolytes 50 or 55, including but not limited to:
water containing one or more dissolved ions, such as, but not limited to: 0-14 M concentrations of Na⁺, K⁺, Ca²⁺, Mg²⁺, OH, SO₄²⁻, HSO₄⁻, Cl, NO₃⁻, ClO₄⁻, phosphates (including HPO₄⁻), carbonates (including HCO₃⁻), PF₆⁻, BF₄⁻, (CF₃SO₂)₂N⁻, or polyelectrolytes that contain polymers with functional groups, such as, but not limited to polystyrene sulfonate, DNA, polypeptides;
non-aqueous liquids containing solutes, such as, but not limited to propylene carbonate or dimethoxyethane or propionitrile liquids containing solutes such as, but not limited to, LiClO₄, or Bu₄NPF₆; or
conductive liquids, such ionic liquids comprising of alkyl-substituted as, but not limited to ambient temperature molten salts or ammonium, imidazolium, or pyridinium cations paired with suitable anions.

### 7. Examples

### 7a. Water Electrolysis Cell for Producing Hydrogen and Oxygen From Water

Example embodiment water electrolysis cells having the architecture depicted in FIG. 1 were fabricated by: (i) using a rigid frame to maintain a fixed distance between the electrodes, or (ii) sandwiching a polyethylene net/mesh (Claf S8520; 0.130 mm thick; 14 strands per 5 cm in each direction) between the electrode, where the electrode comprised a hydrogen-generating cathode electrode 20 and an oxygen generating anode electrode 30.

The cathode electrode 20 was fabricated as taught in the scientific paper entitled: “An Alkaline Water Electrolyzer with Sustainion™ Membranes: 1 A/cm² at 1.9 V with Base Metal Catalysts” by Z. Liu, S. D. Sajjad, Yan Gao, J. J. Kaczur, and R. I. Masel, in ECS Transactions (2017) 77 (9), 71-73, which is incorporated herein by reference. The procedure involved spraying a Sigracet™ carbon paper substrate on its microporous side with a thin catalyst layer of 10% Pt on Vulcan XC-72 (0.5 mg Pt/cm²) with 5% Nafion® as binder (26% by weight). A Ni mesh that served as the current carrier was pressed tight up against the macroporous layer of PTFE-coated carbon fibres at the back face of the Sigracet™ carbon paper substrate, thus prepared. The combination of the Sigracet™ carbon paper substrate, thus prepared, and the Ni mesh, formed the cathode electrode 20. As the Sigracet™ carbon paper substrate, thus prepared, hindered the passage through it of aqueous solutions from the flow channel 40 into the first chamber 60, the cathode electrode 20 was essentially watertight.

The anode electrode 30 comprised of a fine nickel mesh (200 LPI) that had been electrocoated with NiFe catalyst as described in the scientific at Nature Communications 2022, Vol. 13, page 1304 (https://doi.org/10.1038/s41467-022-28953-x) and references therein. A Gore-Tex gas diffusion layer 301 was placed behind the anode electrode 30, between the anode electrode 30 and the second chamber 65 to prevent liquid from the flow channel 40 passing into the second chamber 65.

A highly conductive, high corrosion 6 M KOH liquid electrolyte was passed into the flow channel 40 in one of the following ways: (1) under the impetus of gravity, and/or (2) by pressurising the liquid electrolyte in external first pipe 42 using a pressurised gas as depicted in FIG. 2, and/or (3) by de-pressurising the liquid electrolyte in external second pipe 41 using an ejector as shown in FIG. 2. The 6 M KOH could also be pumped into, out of, or through the flow channel 40 by fitting a pump to external first pipe 42 or external second pipe 41.

With the highly conductive, high corrosion 6 M KOH liquid electrolyte in the flow channel 40, the cell demonstrated a voltage of around 1.71 V at 0.5 A/cm² at 23 °C. For the 1 cm² electrodes in the cell, the impedance (area specific resistance) was measured to be 0.346 Ω cm².

The cell was then re-prepared as described above, however after the highly conductive, high corrosion 6 M KOH liquid electrolyte was passed into the flow channel 40, a voltage differential of 1.2 V was applied to the electrodes 20 and 30 for 30 min. Thereafter, whilst maintaining a voltage of at least 1.2 V across the electrodes 20 and 30, a solution of de-ionised water (liquid electrolyte 55) was passed through flow channel 40. Despite the presence of the de-ionised water, the cell still operated equally efficiently as a water electrolyzer, demonstrating a voltage of around 1.73 V at 0.5 A/cm² at 23 °C. For the 1 cm² electrodes in the cell, the impedance (area specific resistance) was measured to be 0.386 Ω cm², which is very similar to the impedance with the highly conductive, high corrosion 6 M KOH liquid electrolyte in the flow channel 40.

Over time the impedance differential increased slowly but steadily. This could be remedied by circulating 0.1 M KOH instead of de-ionized water as the poorly conductive liquid electrolyte through the flow channel 40. The use of 0.1 M KOH maintained the impedance around 0.386 Ω cm².

If the inter-electrode gap or distance, i.e. width 70, between the electrodes 20, 30 was increased to 0.40 mm, the electrochemical performance showed notable degradation commencing within several hours. With an inter-electrode gap or distance, i.e. width 70 of 0.70 mm or 1 mm, degradation occurred very rapidly indeed, including to full cell failure, within a mere one hour.

These results indicate that the rate of degradation is strongly influenced by the strength of the electric field created by the applied potential difference.

The utilisation of the poorly conductive liquid electrolyte (instead of the highly conductive, high corrosion 6 M KOH electrolyte) led to a significantly lower rate of corrosion in the cell and cell system.

### 7b. Fuel Cell for Producing Electrical Energy From Hydrogen Gas and Oxygen Gas

Example embodiment hydrogen-oxygen fuel cells having the architecture depicted in FIG. 1 were fabricated by sandwiching a polyethylene net (Claf S8520; 0.130 mm thick; 14 strands per 5 cm in each direction) with a hydrogen-generating cathode electrode 20 and an oxygen anode electrode 30.

The electrodes were fabricated as described in Wagner, K., Tiwari, P., Swiegers, G. F. & Wallace, G. G., ‘Alkaline Fuel Cells with Novel Gortex-Based Electrodes are Powered Remarkably Efficiently by Methane Containing 5% Hydrogen’, Advanced Energy Materials, 8 (7), 1702285-1-1702285-10, incorporated herein by reference.

A highly conductive, high corrosion 6 M KOH liquid electrolyte was passed into the flow channel 40 in one of the following ways: (1) under the impetus of gravity, and/or (2) by pressurising the liquid electrolyte in external first pipe 42 using a pressurised gas as depicted in FIG. 2, and/or (3) by de-pressurising the liquid electrolyte in external second pipe 41 using an ejector as shown in FIG. 2. The 6 M KOH could also be pumped into, out of, or through the flow channel 40 by fitting a pump to external first pipe 42 or external second pipe 41.

The introduction of hydrogen gas into the hydrogen chamber and oxygen gas into the oxygen chamber led to the spontaneous creation of a potential difference (i.e. a voltage) between the electrodes 20, 30.

The flow into, out of, or through the flow channel 40 was then switched to a flow of de-ionized water. The voltage produced by the fuel cell was largely maintained despite the flow of a poorly conductive liquid electrolyte into, out of, or through the flow channel 40.

The utilisation of the poorly conductive liquid electrolyte (instead of the highly conductive, high corrosion 6 M KOH electrolyte) led to a significantly lower rate of corrosion in the cell and cell system.

### 7c. Analysis of Capacitively Concentrated Ions at or About an Electrode

Two identical electrolysis cells, each employing electrodes of the type described in Example 1 above and having an inter-electrode separation of 0.14 mm were prepared. The inter-electrode gap of each cell was filled with a solution of 1 M KOH. One of the cells, i.e. the test cell, had a potential difference of 1.2 V applied across the electrode for 2 h; the electric field was ~86 V cm⁻¹. The other cell, the control cell, had no voltage applied across the electrodes during the 2 h. Immediately prior to the end of the 2 h protocol, while the applied voltage was still being applied to the test cell, the liquid electrolyte in the inter-electrode gap of both cells was drained. Immediately after the end of the protocol, each cell, i.e. the test cell and the control cell, was separately disassembled and the components of each separately soaked in separate de-ionized water baths, each of known, fixed volume (50 mL). After soaking, each water bath was analyzed by titration with 0.024 M HCl using a standard titration procedure. The results indicated that the bath used for the test cell had ~3-6-time the concentration of KOH present in the bath used for the control cell, indicating that the KOH ions had been capacitively concentrated at or about the or an electrode/s in the test cell during the 2 h protocol.

### 8. Combinations of Features

According to various non-limiting example embodiments, the following points disclose combinations of features that provide various example cells, multi-cell stacks, systems and/or example methods of operation.
1. An electro-synthetic or electro-energy cell, comprising:
   a first electrode;
   a second electrode; and
   a liquid flow channel positioned between the first electrode and the second electrode, the liquid flow channel for supplying a liquid electrolyte to the first electrode and the second electrode, the liquid flow channel having a width of 0.20 mm or less.
2. An electro-synthetic or electro-energy cell, comprising:
   a first electrode;
   a second electrode; and
   a liquid flow channel positioned between the first electrode and the second electrode, the liquid flow channel for supplying a liquid electrolyte to the first electrode and the second electrode, the liquid flow channel being fully occupied with liquid and the liquid flow channel having a width of 0.20 mm or less.
3 The cell of one or more preceding points, wherein the liquid of the liquid flow channel is a poorly conductive liquid electrolyte.
4. The cell of one or more preceding points, wherein the liquid flow channel contains a porous spacer to preventing the first electrode and the second electrode from touching.
5. The cell of one or more preceding points, wherein the cell is configured to flow a poorly conductive liquid electrolyte through the liquid flow channel.
5A. The cell of one or more preceding points, wherein the poorly conductive liquid electrolyte flows during operation of the cell.
6. The cell of one or more preceding points, wherein ions are capacitively concentrated at an electrode selected from the set consisting of the first electrode and the second electrode.
7. The cell of one or more preceding points, wherein the cell is a water electrolysis cell.
8. The cell of one or more preceding points, wherein the cell is a hydrogen oxygen fuel cell.
9. The cell of one or more preceding points, wherein the impedance is less than or equal to 1.20 Ω cm².
10. The cell of one or more preceding points, wherein the poorly conductive liquid electrolyte is also a low corrosion electrolyte.
11. The cell of one or more preceding points, wherein ions are capacitively concentrated at at least one of the first electrode and the second electrode.
12. The cell of one or more preceding points, including a porous spacer positioned in the liquid flow channel.
13. The cell of one or more preceding points, wherein the porous spacer is a highly porous spacer that has a porosity of more than 60%.
14. The cell of one or more preceding points, wherein the porous spacer is a highly porous spacer having a porosity (i.e. a void volume) of more than 62%, more than 64%, more than 66%, more than 68%, more than 70%, more than 72%, more than 74%, more than 76%, more than 78%, more than 80%, more than 82%, more than 84%, more than 86%, more than 88%, or more than 90%.
15. The cell of one or more preceding points, wherein the porous spacer completely fills the liquid flow channel.
16. The cell of one or more preceding points, wherein the porous spacer partially fills the liquid flow channel.
17. The cell of one or more preceding points, wherein the porous spacer has a thickness of 0.20 mm or less.
18. The cell of one or more preceding points, wherein the porous spacer is substantially flat, non-conductive, and liquid-permeable.
19. The cell of one or more preceding points, wherein the porous spacer is a polymer net or a polymer mesh.
20. The cell of one or more preceding points, wherein the porous spacer is a polyolefin polymer net.
21. The cell of one or more preceding points, wherein the porous spacer is a porous capillary spacer.
22. The cell of one or more preceding points, wherein the porous spacer or porous capillary spacer is manufactured from an electrically insulating material or non-conductive material, including various types, or combinations of types, or hybrids of different types of: PVDF, PTFE, tetrafluoroethylene, fluorinated polymers of various types; polyimides, polyamides, nylon, nitrogen-containing materials of various types; glass fibre, silicon-containing materials of various types; polyvinyl chloride, chloride-containing polymers of various types, cellulose acetate, cellulose nitrate, cellophane, ethyl-cellulose, cellulose-containing materials of various types; polycarbonate, carbonate-containing materials of various types; polyethersulfone, polysulfone, polyphenylsulfone, sulfone-containing materials of various types; polyphenylene sulphide, sulphide-containing materials of various types; polypropylene, polyethylene, polyolefins, olefin-containing materials of various types; asbestos, titanium-based ceramics, zirconium-based ceramics, ceramic materials of various types; polyvinyl chloride, vinyl-based materials of various types; rubbers of various types; or porous battery separators of various types; or clays of various types.
23. The cell of one or more preceding points, wherein the width of the liquid flow channel is maintained by sandwiching the first electrode and the second electrode against opposite sides of the porous spacer.
24. The cell of one or more preceding points, wherein the porous capillary spacer extends outside of the flow channel between the first electrode and the second electrode.
25. The cell of one or more preceding points, wherein the porous capillary spacer extends beyond the first electrode and the second electrode.
26. The cell of one or more preceding points, wherein the liquid electrolyte flows into or out of the flow channel by flowing within a first portion and/or a second portion of the porous capillary spacer located outside of the flow channel.
27. The cell of one or more preceding points, wherein the first portion of the porous capillary spacer provides a first capillary pipeline to supply the liquid electrolyte to the liquid flow channel.
28. The cell of one or more preceding points, wherein the second portion of the porous capillary spacer provides a second capillary pipeline to extract the liquid electrolyte from the liquid flow channel.
29. The cell of one or more preceding points, wherein the liquid electrolyte flows into or out of the flow channel by flowing within a separate porous capillary spacer located outside of the flow channel.
30. The cell of one or more preceding points, wherein the flow channel is completely filled by two or more porous capillary spacers.
31. The cell of one or more preceding points, wherein the flow channel is partially filled by two or more porous capillary spacers.
32. The cell of one or more preceding points, wherein at least one of the two or more porous capillary spacers extends outside of the flow channel.
33. The cell of one or more preceding points, wherein at least one of the two or more porous capillary spacers extends beyond the first electrode and/or the second electrode.
34. The cell of one or more preceding points, including a first porous capillary spacer, a second porous capillary spacer, and a third porous capillary spacer.
35. The cell of one or more preceding points, wherein the first electrode and the second electrode are compressed against the porous spacer with a clamping force of 2 bar or more.
36. The cell of one or more preceding points, wherein the first electrode and the second electrode are compressed against the porous spacer with a clamping force of 3 bar or more, 5 bar or more, 7 bar or more, 9 bar or more, 10 bar or more, 12 bar or more, 14 bar or more, 15 bar or more, 20 bar or more, 25 bar or more, 30 bar or more, 35 bar or more, or 50 bar or more.
37. The cell of one or more preceding points, wherein the first electrode and the second electrode are compressed against the porous capillary spacer with a clamping force of 2 bar or more, 3 bar or more, 5 bar or more, 7 bar or more, 9 bar or more, 10 bar or more, 12 bar or more, 14 bar or more, 15 bar or more, 20 bar or more, 25 bar or more, 30 bar or more, 35 bar or more, or 50 bar or more.
38. The cell of one or more preceding points, wherein the first electrode is a first gas diffusion electrode and is in direct contact with a body of a first gas that is located in a first chamber on the opposite side of the first electrode to the liquid flow channel.
39. The cell of one or more preceding points, including a first gas diffusion layer placed between the first electrode and the first chamber containing the body of the first gas.
40. The cell of one or more preceding points, wherein the second electrode is a second gas diffusion electrode and is in direct contact with a body of a second gas that is located in a second chamber on the opposite side of the second electrode to the liquid flow channel.
41. The cell of one or more preceding points, including a second gas diffusion layer placed between the second electrode and the second chamber containing the body of the second gas.
42. The cell of one or more preceding points, wherein the first gas is a gas produced by or consumed by the first electrode.
43. The cell of one or more preceding points, wherein the first electrode is a gas diffusion electrode that hinders the movement of liquid through the first electrode from the liquid flow channel into a first chamber containing the body of the first gas.
44. The cell of one or more preceding points, including a gas diffusion layer that halts liquid intrusion being placed between the first electrode and the first chamber containing the body of the first gas.
45. The cell of one or more preceding points, wherein the second gas is a gas produced by or consumed by the second electrode.
46. The cell of one or more preceding points, wherein the second electrode is a gas diffusion electrode that hinders the movement of liquid through the second electrode from the liquid flow channel into a second chamber containing the body of the second gas.
47. The cell of one or more preceding points, including a gas diffusion layer that halts liquid intrusion being placed between the second electrode and the second chamber containing the body of the second gas.
48. The cell of one or more preceding points, wherein the liquid electrolyte passes into or out of the flow channel via an external first pipe and/or via an external second pipe.
49. The cell of one or more preceding points, wherein more than one external pipe may be connected to the liquid flow channel.
50. The cell of one or more preceding points, wherein the liquid electrolyte passes into the flow channel via the external first pipe under the influence of gravity, and the liquid electrolyte passes out of the flow channel via the external second pipe under the influence of gravity.
51. The cell of one or more preceding points, wherein the external first pipe is connected to a pressure vessel, wherein the pressure vessel contains the liquid electrolyte and a pressurised gas.
52. The cell of one or more preceding points, wherein the liquid electrolyte is pressurised to flow into the flow channel via the external first pipe and to flow out of the flow channel via the external second pipe.
53. The cell of one or more preceding points, including an ejector attached to the external second pipe and adapted to cause liquid electrolyte to flow out of the flow channel into the external second pipe.
54. The cell of one or more preceding points, including a pump connected to the external first pipe or the external second pipe to cause the liquid electrolyte to flow into, out of, or through the flow channel.
55. The cell of one or more preceding points, wherein the width of the liquid flow channel is equal to or less than 0.18 mm, equal to or less than 0.16 mm, equal to or less than 0.14 mm, equal to or less than 0.12 mm, equal to or less than 0.10 mm, equal to or less than 0.08 mm, equal to or less than 0.06 mm, equal to or less than 0.04 mm, or equal to or less than 0.02 mm.
56. The cell of one or more preceding points, wherein the liquid electrolyte is a poorly conductive liquid electrolyte.
57. The cell of one or more preceding points, wherein the poorly conductive liquid electrolyte has a specific conductivity of less than or equal to 0.1 S cm⁻¹ at 80 °C.
58. The cell of one or more preceding points, wherein the liquid electrolyte is a 0.0 to about 0.2 M aqueous solution of KOH, NaOH, H₂SO₄, HClO₄, or HCl.
59. The cell of one or more preceding points, wherein during a start-up procedure, the liquid electrolyte is a highly conductive liquid electrolyte.
60. The cell of one or more preceding points, wherein the highly conductive liquid electrolyte has a specific conductivity of more than 0.1 S cm⁻¹ at 80 °C.
61. The cell of one or more preceding points, wherein prior to operation or during certain periods of operation of the cell, the liquid electrolyte that flows into, out of, or through the liquid flow channel between the electrodes is a highly conductive liquid electrolyte.
62 The cell of one or more preceding points, wherein during operation or during certain periods of operation of the cell, the liquid electrolyte that flows into, out of, or through the liquid flow channel between the electrodes is a poorly conductive liquid electrolyte.
63. The cell of one or more preceding points, containing a poorly conductive liquid electrolyte that exhibits reduced corrosion.
64. The cell of one or more preceding points, wherein liquid electrolyte passing into, out of, or through the liquid flow channel is constrained by capillary forces of the porous capillary spacer to largely remain in the liquid flow channel.
65. The cell of one or more preceding points, wherein portions of the capillary spacer located outside of the liquid flow channel are capillary pipelines within which liquid electrolyte may flow to or from the liquid flow channel and, from there, into, out of, or through the liquid flow channel.
66. The cell of one or more preceding points, wherein liquid electrolyte flows into or out of the liquid flow channel, by flowing along and within those portions of the porous capillary spacer located outside of the liquid flow channel.
67. The cell of one or more preceding points, including two or more porous capillary spacers.
68. The cell of one or more preceding points, wherein one or more capillary pipelines located outside of the liquid flow channel are in fluid communication with one or more porous capillary spacers within the liquid flow channel.
69. The cell of one or more preceding points, wherein the at least one porous capillary spacer in the liquid flow channel forms part of and is contiguous with a porous capillary spacer located outside of the liquid flow channel that provides a capillary pipeline to or from the liquid flow channel.
70. The cell of one or more preceding points, including one, two, three, or more porous capillary spacers may be in the liquid flow channel.
71. The cell of one or more preceding points, wherein each porous capillary spacer in the liquid flow channel forming part of and being contiguous with a porous capillary spacer located outside of the liquid flow channel that provides a capillary pipeline to or from the liquid flow channel.
72. The cell of one or more preceding points, wherein the liquid electrolyte flows via one or more capillary pipelines located outside of the liquid flow channel, to or from the liquid flow channel, and thereby into, out of, or through the liquid flow channel.
73. The cell of one or more preceding points, wherein the capillary pipelines are separate to, and non-contiguous with porous capillary spacers present within the liquid flow channel.
74. The cell of one or more preceding points, wherein there is no porous capillary spacer within the liquid flow channel, and wherein liquid flowing to or from the liquid flow channel, and thereby into, out of, or through the liquid flow channel, does so along the one or more capillary pipelines that are located outside of the liquid flow channel but are in fluid communication with the liquid flow channel.
75. The cell of one or more preceding points, wherein diffusion or osmosis, alternatively or additionally, induces movement of the liquid electrolyte along and within the one or more porous capillary spacers, including the one or more porous capillary spacers that form capillary pipelines.
76. The cell of one or more preceding points, wherein the liquid electrolyte is induced to flow into, out of, or through the liquid flow channel under the additional impetus of gravity, and/or by pressurising or de-pressurising the liquid electrolyte.
77. The cell of one or more preceding points, wherein the highly conductive liquid electrolyte is a about 0.2 to 12.0 M aqueous solution of KOH, NaOH, H₂SO₄, HClO₄, or HCl.
78. The cell of one or more preceding points, wherein the liquid electrolyte is:
   water containing one or more dissolved ions;
   water containing 0-14 M concentrations of Na⁺, K⁺, Ca²⁺, Mg²⁺, OH, SO₄²⁻, HSO₄⁻, Cl, NO₃⁻, ClO₄⁻, phosphates; HPO₄⁻; carbonates; HCO₃⁻, PF₆⁻, BF₄⁻, or (CF₃SO₂)₂N⁻;
   water containing polyelectrolytes that contain polymers with functional groups;
   water containing polystyrene sulfonate, DNA, or polypeptides;
   non-aqueous liquids containing solutes;
   non-aqueous liquids containing propylene carbonate or dimethoxyethane;
   propionitrile liquids containing solutes;
   propionitrile liquids containing LiClO₄ or Bu₄NPF₆;
   conductive liquids; or
   conductive liquids containing alkyl-substituted molten salts or ammonium, imidazolium, or pyridinium cations.
79. A method of operating an electro-synthetic or electro-energy cell,
   the cell comprising:
      a first electrode;
      a second electrode; and
      a liquid flow channel positioned between the first electrode and the second electrode, the liquid flow channel for supplying a liquid electrolyte to the first electrode and the second electrode, and the liquid flow channel having a width of 0.20 mm or less;
   the method comprising:
      filling the flow channel with a liquid electrolyte; and
      applying a potential difference between the first electrode and the second electrode to cause ions to be capacitively concentrated at at least one of the first electrode and the second electrode. Applying a potential difference may occur during operation of the cell.
80. A method of operating an electro-synthetic or electro-energy cell,
   the cell comprising:
      a first electrode;
      a second electrode; and
      a liquid flow channel positioned between the first electrode and the second electrode, the liquid flow channel for supplying a liquid electrolyte to the first electrode and the second electrode, the liquid flow channel being fully occupied with liquid and the liquid flow channel having a width of 0.20 mm or less;
   the method comprising:
      filling the flow channel with a liquid electrolyte; and
      applying a potential difference between the first electrode and the second electrode to cause ions to be capacitively concentrated at at least one of the first electrode and the second electrode. Applying a potential difference may occur during operation of the cell.
81. A method of operating an electro-synthetic or electro-energy cell,
   the cell comprising:
      a first electrode;
      a second electrode; and
      a liquid flow channel positioned between the first electrode and the second electrode, the liquid flow channel for supplying a liquid electrolyte to the first electrode and the second electrode, and the liquid flow channel having a width of 0.20 mm or less;
   the method comprising:
      filling the flow channel with a highly conductive liquid electrolyte;
      applying a potential difference between the first electrode and the second electrode, to thereby form a poorly conductive liquid electrolyte from the highly conductive liquid electrolyte; and
      flowing the poorly conductive liquid electrolyte through the flow channel. The poorly conductive liquid electrolyte may flow through the flow channel during operation of the cell.
82. A method of operating an electro-synthetic or electro-energy cell,
   the cell comprising:
      a first electrode;
      a second electrode; and
      a liquid flow channel positioned between the first electrode and the second electrode, the liquid flow channel for supplying a liquid electrolyte to the first electrode and the second electrode, the liquid flow channel being fully occupied with liquid and the liquid flow channel having a width of 0.20 mm or less;
   the method comprising:
      filling the flow channel with a highly conductive liquid electrolyte;
      applying a potential difference between the first electrode and the second electrode; and
      flowing the poorly conductive liquid electrolyte through the flow channel. The poorly conductive liquid electrolyte may flow through the flow channel during operation of the cell.
83. The method of one or more of points 79 to 82, wherein ions are capacitively concentrated at at least one of the first electrode and the second electrode during operation of the cell.
84. A method of operating an electro-synthetic or electro-energy cell, using a poorly conductive liquid electrolyte, such that the cell has a low impedance, as demonstrated by high conductivity between the electrodes as well as high catalytic activities, or promotion thereof, by the electro-catalysts employed on the electrodes, the method involving:
   filling the liquid flow channel of the electro-synthetic or electro-energy cell with a highly conductive liquid electrolyte;
   applying a potential difference across the electrodes of the cell in order to induce the ions of the highly conductive liquid electrolyte to largely ion-pair with the polarised electrodes, thereby capacitively de-ionising the liquid electrolyte between the electrodes;
   flowing the poorly conductive liquid electrolyte into, out of, or through the liquid flow channel of the cell and within an associated cell system, whilst simultaneously having a low impedance;
   maintaining a low impedance between the first electrode and the second electrode of the cell. In another example aspect, the method further incorporates an additional step of operating the cell.
85. The method of one or more of points 79 to 84, wherein a low impedance between the first electrode and the second electrode of the cell is maintained due to a local concentration of ions at the first electrode and the second electrode, from where the ions migrate to the other electrode, which is located close or nearby, causing resistance to ion migration between the electrodes to be low, and also promoting high catalytic activity by the electro-catalysts employed on the electrodes.
86. The method of one or more of points 79 to 85, wherein re-generating a cell that no longer has low impedance is performed by repeating the method steps.
87. The method of one or more of points 79 to 86, wherein prior to or during operation of the cell, the liquid flow channel is filled with a liquid electrolyte and the liquid electrolyte flows into, out of, or through the liquid flow channel.
88. The method of one or more of points 79 to 87, wherein the flow of liquid electrolyte into, out of, or through the liquid flow channel is driven by gravity, and/or by pressurising and/or de-pressurising the liquid electrolyte in an external pipe connected to the liquid flow channel.
89. The method of one or more of points 79 to 88, wherein the liquid electrolyte is impelled to flow into, out of, or through the liquid flow channel by a pressure applied within an external pipe connected to the liquid flow channel.
90. The method of one or more of points 79 to 89, wherein the liquid electrolyte is impelled to flow into, out of, or through the liquid flow channel by de-pressurising the liquid electrolyte within an external pipe connected to the liquid flow channel.
91. The method of one or more of points 79 to 90, including a method of slowing degradation in the impedance of the cell, wherein the degradation in the impedance derives from a progressive loss of capacitively held ions at the electrodes, comprising adding replenishment ions to the poorly conductive liquid electrolyte that flows into, out of, or through the liquid flow channel of the cell.
92. The method of one or more of points 79 to 91, wherein a porous spacer is positioned in the liquid flow channel.
92A. The method of one or more of points 79 to 92, wherein the liquid flow channel is fully occupied with liquid during operation of the cell
93. The method of one or more of points 79 to 92A, wherein the cell has an impedance between the first electrode and the second electrode of 1.2 Ω cm² or less.
94. The method of one or more of points 79 to 93, wherein the cell has an impedance between the first electrode and the second electrode of less than or equal to 1.00 Ω cm², less than or equal to 0.80 Ω cm², less than or equal to 0.60 Ω cm², less than or equal to 0.40 Ω cm², less than or equal to 0.35 Ω cm², less than or equal to 0.30 Ω cm², less than or equal to 0.25 Ω cm², less than or equal to 0.20 Ω cm², less than or equal to 0.15 Ω cm², less than or equal to 0.13 Ω cm², less than or equal to 0.11 Ω cm², less than or equal to 0.09 Ω cm² , less than or equal to 0.07 Ω cm², less than or equal to 0.05 Ω cm², less than or equal to 0.04 Ω cm², less than or equal to 0.03 Ω cm², less than or equal to 0.02 Ω cm², or less than or equal to 0.01 Ω cm².
95. The method of one or more of points 79 to 94, wherein the applied potential difference between the first electrode and the second electrode is more than +0.2 V or less than −0.2 V.
96. The method of one or more of points 79 to 95, wherein the applied potential difference between the first electrode and the second electrode is more than +0.4 V or less than −0.4 V, more than +0.6 V or less than −0.6 V, more than +0.8 V or less than −0.8 V, more than +1.0 V or less than −1.0 V, more than +1.1 V or less than −1.1 V, more than +1.2 V or less than −1.2 V, more than +1.3 V or less than −1.3 V, more than +1.4 V or less than −1.4 V, more than +1.5 V or less than −1.5 V, more than +1.6 V or less than −1.6 V, more than +1.7 V or less than −1.7 V, more than +1.8 V or less than −1.8 V, more than +1.9 V or less than −1.9 V, more than +2.0 V or less than −2.0 V, more than +2.1 V or less than −2.1 V, more than +2.3 V or less than −2.3 V, more than +2.5 V or less than −2.5 V, more than +3.0 V or less than −3.0 V, or more than +5.0 V or less than −5.0 V.
97. The method of one or more of points 79 to 96, wherein if cell degradation results from loss of ions at a surface of the first electrode or the second electrode, then a solution with replenishment ions is introduced to the liquid electrolyte.
98. The method of one or more of points 79 to 97, wherein the solution with replenishment ions is equal to or less than 0.1 M KOH.
99. The method of one or more of points 79 to 98, wherein the poorly conductive liquid electrolyte is a low corrosion liquid electrolyte.
100. The method of one or more of points 79 to 99, wherein the cell is an electro-synthetic water electrolysis cell for producing hydrogen and oxygen from water.
101. The method of one or more of points 79 to 100, wherein the cell is an electro-energy fuel cell for producing electrical energy from hydrogen gas and oxygen gas.

Throughout this specification and the claims that follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

Optional embodiments may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although preferred embodiments have been described in detail, it should be understood that many modifications, changes, substitutions or alterations will be apparent to those skilled in the art without departing from the scope of the present invention.

1. An electro-synthetic or electro-energy cell, comprising:
a first electrode;
a second electrode; and
a liquid flow channel positioned between the first electrode and the second electrode, the liquid flow channel for supplying a liquid electrolyte to the first electrode and the second electrode, the liquid flow channel being fully occupied with liquid and the liquid flow channel having a width of 0.20 mm or less.

2. The cell of claim 1, wherein the liquid of the liquid flow channel is a poorly conductive liquid electrolyte.

3. The cell of claim 1, wherein the liquid flow channel contains a porous spacer configured to prevent the first electrode and the second electrode from touching.

4-6. (canceled)

7. The cell of claim 1, wherein the cell is a water electrolysis cell or a hydrogen oxygen fuel cell.

8. (canceled)

9. The cell of claim 1, wherein the impedance between the first electrode and the second electrode is less than or equal to 1.20 Ω cm².

10. The cell of claim 2, wherein the poorly conductive liquid electrolyte is also a low corrosion electrolyte.

11. The cell of claim 3, wherein the porous spacer is a highly porous spacer that has a porosity of more than 60%.

12. (canceled)

13. (canceled)

14. The cell of claim 3, wherein the porous spacer has a thickness of 0.20 mm or less.

15. The cell of claim 3, wherein the porous spacer is substantially flat, non-conductive, and liquid-permeable.

16. The cell of claim 3, wherein the porous spacer is selected from the group consisting of a polymer net or a polymer mesh a polyolefin polymer net, and a porous capillary spacer.

17. (canceled)

18. (canceled)

19. The cell of claim 3, wherein the porous spacer is a porous capillary spacer and extends outside of the flow channel between the first electrode and the second electrode.

20. (canceled)

21. The cell of claim 19, wherein the liquid electrolyte flows into or out of the flow channel by flowing within a first portion and/or a second portion of the porous capillary spacer located outside of the flow channel.

22. The cell of claim 21, wherein the first portion of the porous capillary spacer provides a first capillary pipeline to supply the liquid electrolyte to the liquid flow channel.

23. The cell of claim 21, wherein the second portion of the porous capillary spacer provides a second capillary pipeline to extract the liquid electrolyte from the liquid flow channel.

24. The cell of claim 19, wherein the liquid electrolyte flows into or out of the flow channel by flowing within a separate porous capillary spacer located outside of the flow channel.

25-29. (canceled)

30. The cell of claim 3, wherein the first electrode and the second electrode are compressed against the porous spacer with a clamping force of 2 bar or more.

31-35. (canceled)

36. The cell of claim 1, wherein the liquid electrolyte passes into or out of the flow channel via an external first pipe and/or via an external second pipe.

37-39. (canceled)

40. The cell of claim 36, including an ejector attached to the external second pipe and adapted to cause liquid electrolyte to flow out of the flow channel into the external second pipe.

41. The cell of claim 36, including a pump connected to the external first pipe or the external second pipe to cause the liquid electrolyte to flow into, out of, or through the flow channel.

42-48. (canceled)

49. A method of operating an electro-synthetic or electro-energy cell, the cell comprising:
a first electrode;
a second electrode; and
a liquid flow channel positioned between the first electrode and the second electrode, the liquid flow channel for supplying a liquid electrolyte to the first electrode and the second electrode, the liquid flow channel being fully occupied with liquid and the liquid flow channel having a width of 0.20 mm or less;
the method comprising:
filling the flow channel with a liquid electrolyte; and
applying a potential difference between the first electrode and the second electrode to cause ions to be capacitively concentrated at-at least one of the first electrode and the second electrode.

50-62. (canceled)
